(19) United States
(12) Patent Application Publication
(10) Pub. No.: US 2011/0043471 A1
(43) Pub. Date: Feb. 24, 2011

(54) TOUCH SENSOR METHODS AND APPARATUS

(75) Inventors: Michiru Senda, Aichi (JP); Yoshiharu Nakajima, Kanagawa (JP); Keiichiro Ishihara, Aichi (JP); Tsutomu Tanaka, Kanagawa (JP); Makoto Takatoku, Aichi (JP); Masanobu Ikeda, Aichi (JP); Ryoichi Ito, Aichi (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/851,766

(22) Filed: Aug. 6, 2010

(30) Foreign Application Priority Data
Aug. 19, 2009 (JP) P2009-190109

(51) Int. Cl. G06F 3/041

(52) U.S. Cl. 345/173

(57) ABSTRACT

Touch sensor methods and apparatus are provided. A first photodiode includes an i-region of a first length. A second photodiode includes an i-region with a second length. A sensing component including a capacitive element is operably coupled to the first photodiode and the second photodiode. The first length of the i-region of the first photodiode is different than the second length of the i-region of the second photodiode.

### CROSS REFERENCES TO RELATED APPLICATIONS

The present application claims priority to contains subject matter related to that disclosed in Japanese Priority Patent Application JP 2009-190109 filed in the Japan Patent Office on Aug. 19, 2009, the entire contents of which are hereby incorporated by reference.

### BACKGROUND

The present disclosure relates to touch sensor methods and apparatus. For example, a touch sensor is used in position detection of a proximity object or the like, a method of driving a touch sensor, a method of manufacturing a touch sensor, a display device and an electronic device for touch sensing or touch detection.

In the prior art, various techniques for detecting position or the like of an object which is in contact with or brought close to a display screen in a display device have been established. Among them, a typical technique which is generally widespread, there is a display device including a touch panel.

Various types of touch panels exist, and there is a capacitance-detection type touch panel as a touch panel which is typical. In the touch panel of this type, the touch panel is touched by a finger and changes of electric charge on a panel surface are captured, and this allows position detection or the like of the object. Thus, by using such a touch panel, it is possible for a user to intuitively operate the touch panel.

By the present assignee, for example, a display device including a display section (display and image pickup panel) which has a display function displaying an image, and an image pickup function (detection and sensor function) picking up an image of, or detecting the object has been proposed in Japanese Unexamined Patent Application Publication Nos. 2004-127272, and 2006-276223.

### SUMMARY

When the display device described in Japanese Unexamined Patent Application Publication No. 2004-127272 is utilized, for example, in the case where an object such as a finger is brought close to the display and image pickup panel or the like, it is possible to detect position or the like of the object based on a picked-up image by utilizing reflection light irradiated from the display and image pickup panel, and then reflected by the object. Thus, by utilizing this display device, it is possible to detect position or the like of the object with a simple structure, without separately providing a component such as the touch panel on the display and image pickup panel.

However, in the case where reflection light reflected by the object as described above is utilized, external light (environmental light), characteristics variation among photo-reception elements, and the like may be issues. Specifically, luminance of received light is varied according to brightness of the external light, and thus it may be difficult to detect the position or the like of the object based on the picked-up image. Further, the characteristics variation among the photo-reception elements causes a fixed noise, and thus it may be difficult to detect the position or the like of the object based on the picked-up image.

Therefore, in Japanese Unexamined Patent Application Publication No. 2006-276223, the above-described influence of the external light and the fixed noise is eliminated by taking a difference between an image obtained in the light-on state (image obtained by utilizing the reflection light caused by the irradiation light), and an image obtained in the light-off state.

Specifically, for example, as illustrated in Part (A) of FIG. 32, in the case where an incident external light (environmental light) L0 is strong, a photo-reception output voltage Von101 in the state where a backlight 105 is turned on becomes as illustrated in Part (B) of FIG. 32. That is, in the place other than the place touched by a finger “f” in a display area 101, the photo-reception output voltage Von101 becomes a voltage value Va corresponding to the brightness of the environmental light L0. In the place touched by the finger “f” in the display area 101, the photo-reception output voltage Von101 is reduced to a voltage value Vb corresponding to reflectance when an irradiation light Lon from the backlight 105 is reflected by the surface of the object (finger “f”) making a touch at that time. On the other hand, in the place other than the place touched by the finger “f”, a photo-reception output voltage Voff101 in the state where the backlight 105 is turned off becomes the voltage value Va corresponding to the brightness of the environmental light L0, as in the same manner as the photo-reception output voltage Von101. However, in the place touched by the finger “f”, the environmental light L0 is shut off, and the photo-reception output voltage Voff101 becomes a voltage value Vc which is at an extremely low level.

For example, as illustrated in Part (A) of FIG. 33, in the state where the incident environmental light L0 is weak (substantially absent), a photo-reception output voltage Von201 in the state where the backlight 105 is turned on becomes as illustrated in Part (B) of FIG. 33. That is, in the place other than the place touched by the finger “f” in the display area 101, since the environmental light L0 is not present, the photo-reception output voltage Von201 becomes the voltage value Vc which is at the extremely low level. In the place touched by the finger “f” in the display area 101, the photo-reception output voltage Von201 is increased to the voltage Vb corresponding to the reflectance when the irradiation light Lon from the backlight 105 is reflected by the surface of the object (finger “f”) making a touch at that time. On the other hand, in both of the place touched by the finger “f”, and the place other than that touched place, the photo-reception output voltage Voff201 in the state where the backlight 105 is turned off is not varied and remains as the voltage value Vc which is at the extremely-low level.

In this manner, in the place which is not touched by the finger “f” in the display area 101, the photo-reception output voltage is highly different between the case where the environmental light L0 is present and the case where the environmental light L0 is not present. In contrast, in the place touched by the finger “f” in the display area 101, regardless of existence or non-existence of the environmental light L0, the voltage Vb when the backlight 105 is turned on, and the voltage Vc when the backlight 105 is turned off are substantially in the same state. Thus, by detecting the difference between the voltage when the backlight 105 is turned on, and the voltage when the backlight 105 is turned off, like the difference between the voltage Vb and the voltage Vc, it is possible to determine the place where the difference of a certain level or more is present as the place to which the object is close or the like. For example, like a difference image “C” illustrated in FIG. 34, it is possible to detect the position or the like of the object without being influenced by the external light and the fixed noise.

However, in the method of detecting the object by using such a difference image “C”, for example, as illustrated in FIG. 34, frame memories and the like are necessary for two images which are an image (image A) when the backlight is off, and an image (image B) when the backlight is on. Accordingly, the component cost is increased.

In this manner, in the above described technique, it is difficult to stably detect the object in contact with or close to the panel regardless of the use situation at that time, while suppressing the manufacturing cost, and there is still room for further improvement.

Thus, for example, a method is considered, in which a sensor element including a first photodiode for charge, a second photodiode for discharge, and a capacitive element is provided, the first photodiode and the second photodiode are controlled to be alternately turned on/off, and the irradiation light for detection is time-divisionally irradiated to the proximity object in synchronization with that on/off control. In this method, when the irradiation light is irradiated to the proximity object, charges are stored or accumulated in the capacitive element through the first photodiode in accordance with the total light amount of the reflection light caused by this irradiation light, and the environmental light. When the irradiation light is not irradiated, electric charges are released from the capacitive element through the second photodiode in accordance with the light amount of the environmental light. By repeating such a charge operation and a discharge operation, the electric charges based on only the component of the reflection light reflected by the proximity object are stored in the capacitive element, while the component of the environmental light is subtracted. A signal in accordance with the electric charges based on only the component of the reflection light is extracted as a detection signal of the sensor element. Thereby, it is possible to obtain object information about the proximity object without being influenced by the environmental light. In the case of this method, theoretically, since the detection signal in which the influence of the environmental light has been already eliminated is obtained, the above-described frame memories for the two images are not necessary, and the number of the frame memory may be one.

In the case where such a sensor element including the first photodiode for charge and the second photodiode for discharge is used, when there is the difference of response characteristics in the diodes between the charge operation time and the discharge operation time, it is difficult to sufficiently subtract the component of the environmental light. As a result, there is a risk that favorable detection may not be performed.

To perform the stable detection operation, control for suppressing the difference in the response characteristics between the two diodes is desirably performed, or the element structure itself is desirably formed as a structure to suppress the difference of the response characteristics. In view of the foregoing, it is desirable to provide a sensor element capable of performing a stable detection operation by structurally reducing a difference in response characteristics between two diode elements, a method of driving the same, a touch sensor device, a display device with an input function, and an electronic device.

In an example embodiment, a touch sensor apparatus includes a first photodiode including a first p-type semiconductor region (“p-region”), a first intrinsic semiconductor region (“i-region”), and a first n-type semiconductor region (“n-region”), wherein the first i-region is defined by a first length defined as a first distance of the first i-region between the first p-region and the first n-region, a second photodiode including a second p-region, a second i-region, and a second n-region, wherein the second i-region is defined by a second length defined as a second distance of the second i-region between the second p-region and the second n-region, and a sensing component operably coupled to the first photodiode and the second photodiode, the sensing component including a capacitive element, wherein the first length is different than the second length.

In an example embodiment, the touch sensor capacitive element is charged by the first photodiode and discharged by the second photodiode.

In an example embodiment, the touch sensor first length is greater than the second length.

In an example embodiment, the touch sensor apparatus first i-region is defined by the first length and a first width, the first length and the first width defining a first area, the second i-region is defined by the second length and a second width, the second length and second first width defining a second area, and the first area is substantially equal to the second area.

In an example embodiment, the touch sensor apparatus first length is greater than the second length.

In an example embodiment, the touch sensor apparatus first width is less than the second width.

In an example embodiment, the touch sensor apparatus first photodiode and the second photodiode have substantially the same time constant.

In an example embodiment, the touch sensor apparatus first i-region is defined by the first length and a first width, the second i-region is defined by the second length and a second width, and the first width is less than the second width.

In an example embodiment, the touch sensor apparatus first photodiode and the second photodiode are connected in series, an input node of the sensing component is connected between the first photodiode and the second photodiode, the capacitive element is connected between the input node and a power source, a first transistor is connected between the input node and a reset voltage source, the gate of the first transistor connected to a reset signal line, a second transistor is connected between the power source and a third transistor, the gate of the second transistor is connected to the input node, and the third transistor is connected between the second transistor and a read line, the gate of the third transistor connected to a read signal line.

In an example embodiment, the touch sensor apparatus first photodiode charges the capacitive element during a first time period, the second photodiode discharges the capacitive element during a second time period after the first time period.

In an example embodiment, the touch sensor apparatus first photodiode charges the capacitive element substantially more than the second photodiode discharges the capacitive element when an object causes a touch state by coming into contact with or close to the touch sensor apparatus during the first time period and the second time period.

In an example embodiment, the touch sensor apparatus and the first photodiode charges the capacitive element substantially the same as the second photodiode discharges the capacitive element when an object is outside the touch sensing range of the touch sensor apparatus during the first time period and the second time period.

In an example embodiment, the touch sensor apparatus first photodiode charges the capacitive element during a third time period after the second time period, the second photodiode discharges the capacitive element during a fourth time period after the third time period.

In an example embodiment, the touch sensor apparatus first photodiode and the second photodiode are individually controlled to be turned on and off.

In an example embodiment, the touch sensor apparatus first electric charge generated in the first photodiode is accumulated in the capacitive element when the first photodiode is turned on and the second photodiode is turned off, and a second electric charge generated in the second photodiode is released from the capacitive element when the second photodiode is turned on and the first photodiode is turned off.

In an example embodiment, the touch sensor apparatus the first photodiode includes a first gate electrode, a first anode electrode connected to the first p-region, and a first cathode electrode connected to the first n-region, and the second photodiode includes a second gate electrode, a second anode electrode connected to the second p-region, and a second cathode electrode connected to the second n-region, the second cathode electrode is connected to the first anode electrode, so that the first diode element and the second diode element are connected to each other in series, the first photodiode is turned on and off through changing a first potential relationship between the first cathode electrode and the first gate electrode, and the second photodiode is turned on and off through changing a second potential relationship between the second anode electrode and the second gate electrode.

In an example embodiment, the touch sensor apparatus a first fixed voltage is applied to the first gate electrode and a second fixed voltage is applied to the second gate electrode, and a first pulse is applied to the first cathode electrode and a second pulse is applied to the second anode electrode.

In an example embodiment, the touch sensor apparatus response characteristics of the first photodiode and the second photodiode are different.

In an example embodiment, the touch sensor apparatus further includes a substrate, which includes a plurality of pixels arranged in a matrix on the substrate for touch sensing, each pixel including a first photodiode, a second photodiode, and a sensing component.

In an example embodiment, an electronic device includes a plurality of pixels, each of the plurality of pixels including, a first photodiode including a first p-type semiconductor region p-region, a first i-region, and a first n-region, wherein the first i-region is defined by a first length defined as a first distance of the first i-region between the first p-region and the first n-region, a second photodiode including a second p-region, a second i-region, and a second n-region, wherein the second i-region is defined by a second length defined as a second distance of the second i-region between the second p-region and the second n-region, and a sensing component operably coupled to the first photodiode and the second photodiode, the sensing component including a capacitive element, wherein the first length is different than the second length.

In an example embodiment, the electronic device is at least one of a television, a digital camera, a personal computer, a notebook computer, a tablet computer, a video camera, and a mobile phone.

In an example embodiment, a display device includes a plurality of display pixels, a plurality of first photodiodes, each first photodiode including a first p-region, a first i-region, and a first n-region, wherein the first i-region is defined by a first length defined as a first distance of the first i-region between the first p-region and the first n-region, a plurality of second photodiodes, each second photodiode including a second p-region, a second i-region, and a second n-region, wherein the second i-region is defined by a second length defined as a second distance of the second i-region between the second p-region and the second n-region, and a plurality of sensing components, each sensing component of the plurality of sensing components operably coupled to a corresponding first photodiode and a corresponding second photodiode and including a capacitive element, wherein the first length is different than the second length for each of the pluralities of first photodiodes and second photodiodes.

In an example embodiment, a method of driving a touch sensor includes charging a capacitive element, for a first time period, with a first photodiode including a first p-type semiconductor region p-region, a first i-region, and a first n-region, wherein the first i-region is defined by a first length defined as a first distance of the first i-region between the first p-region and the first n-region, discharging the capacitive element, for a second time period after the first time period, with a second photodiode including a second p-region, a second i-region, and a second n-region, wherein the second i-region is defined by a second length defined as a second distance of the second i-region between the second p-region and the second n-region, wherein the first length is different than the second length, and sensing a charge of the capacitive element after the second time period to determine whether a touch state occurred during the first and second time periods.

An example embodiment, a method of manufacturing a touch sensor apparatus includes charging a capacitive element, for a first time period, with a first photodiode including a first p-type semiconductor region p-region, a first i-region, and a first n-region, wherein the first i-region is defined by a first length defined as a first distance of the first i-region between the first p-region and the first n-region, discharging the capacitive element, for a second time period after the first time period, with a second photodiode including a second p-region, a second i-region, and a second n-region, wherein the second i-region is defined by a second length defined as a second distance of the second i-region between the second p-region and the second n-region, wherein the first length is different than the second length, and determining a first time constant of a first photodiode by sensing a first charge of the capacitive element during the first time period, determining a second time constant of a second photodiode by sensing a first charge of the capacitive element during the first second period, and adjusting at least one of the first length and the second length to cause the first time constant to be substantially equal to the second time constant.

As used herein, the term “external proximity object (which may also be simply referred to as a “proximity object”)” refers not only a close object in a literal sense, but also, for example, an object which is in contact with a touch sensor panel, in the case where the touch sensor panel is formed by arranging the plurality of touch sensor elements in matrix in one plane.

In the touch sensor device, the method of diving the sensor element, the display device with the input function, and the electronic device according to example embodiments of the present disclosure, the length in the first direction (a so-called L length) of the intrinsic semiconductor region (i region) of the first diode element is different from the length in the first direction of the intrinsic semiconductor region of the second diode element. Thereby, an element structure in which a difference in response characteristics between the first diode element and the second diode element is reduced is realized. More specifically, there are characteristics that as the L length becomes shorter, the response characteristics of the diode element becomes faster (time constant indicating current response characteristics when an off state is shifted to an on state becomes smaller). By utilizing those characteristics to optimize the L length, it is possible to reduce the difference in the response characteristics.

According to the touch sensor element, the method of driving the touch sensor element, the touch sensor device, the display device with the input function, and the electronic device of the example embodiments of the present disclosure, the length in the first direction of the intrinsic semiconductor region of the first diode element is made different from the length in the first direction of the intrinsic semiconductor region of the second diode element. This makes it possible to optimize the L lengths, such that the difference in the response characteristics between the first diode element and the second diode element is reduced. By appropriately setting the L lengths, a time constant of the first diode element and a time constant of the second diode element, each of which indicating current response characteristics when an off state is shifted to an on state, are substantially matched. Therefore, it is possible to perform the stable detection operation by suppressing the difference in the response characteristics between the first diode element and the second diode element.

Additional features and advantages are described herein, and will be apparent from the following Detailed Description and the figures.

### BRIEF DESCRIPTION OF THE DRAWINGS

FIG. 1 is a block diagram illustrating a structure example of a display device with an input function according to an example embodiment.

FIG. 2 is a block diagram illustrating a structure example of an I/O display panel illustrated in FIG. 1.

FIG. 3 is a plan view illustrating a pixel arrangement example in a display area (sensor area) illustrated in FIG. 2.

FIG. 4 is a schematic plan view illustrating an example of the connection relationship between a sensor element (image pickup element) and a signal line in the pixel arrangement illustrated in FIG. 3.

FIG. 5 is a circuit diagram illustrating a structure example of the sensor element in the display device illustrated in FIG. 1.

FIG. 6 illustrates an example of the element structure of the sensor element illustrated in FIG. 5, in which part (A) is a plan view of a semiconductor part in the sensor element, and part (B) is a cross-sectional view of the whole sensor element.

FIGS. 7A to 7C are views for explaining an on operation region and an off operation region in a first diode element in the example sensor element illustrated in FIG. 5.

FIGS. 8A to 8C are views for explaining an on operation region and an off operation region in a second diode element in the example sensor element illustrated in FIG. 5.

FIG. 9 is a timing waveform diagram illustrating an example of detection process (image pickup operation) of a proximity object in the display device illustrated in FIG. 1.

FIG. 10 is a circuit diagram for explaining a charge operation in the detection process of the proximity object illustrated in FIG. 9.

FIG. 11 is a circuit diagram for explaining a discharge operation in the detection process of the proximity object illustrated in FIG. 9.

FIG. 12A illustrates an example voltage waveform of a storage node obtained when two diode elements are operated in an ideal state, and FIG. 12B is an example waveform diagram illustrating an actual voltage waveform of the storage node in the case where the difference of the response characteristics between the two diode elements is taken into account.

FIG. 13 is an explanation view for an example voltage rise generated in the storage node due to the difference of the response characteristics between the two diode elements.

FIGS. 14A and 14B are characteristics diagrams illustrating example frequency characteristics (actual measurement values) due to the difference of an L length in the first diode element, in which FIG. 14A illustrates characteristics normalized by a signal voltage when L=12 μm and the frequency is 125 Hz, and FIG. 14B illustrates characteristics normalized by the signal voltage when the frequency is 125 Hz in each L length.

FIG. 15A is a characteristics diagram illustrating typical current response characteristics of the diode element, and FIG. 15B is a characteristics diagram illustrating typical voltage response characteristics of the diode element.

FIG. 16 is a characteristics diagram comparing the example frequency characteristics using the actual measurement values illustrated in FIG. 14A, and frequency characteristics obtained by reproducing the frequency characteristics using the actual measurement values with a calculation formula.

FIG. 17 is a characteristics diagram illustrating the relationship between the L length and a time constant of a current by using the example actual measurement values and calculation values.

FIGS. 18A and 18B are characteristics diagrams illustrating an example charge/discharge waveform in the sensor element illustrated in FIG. 5, in which FIG. 18A illustrates characteristics in the case where the L length is set to be L=12 μm in the first diode element and the second diode element, and FIG. 18B illustrates characteristics in the case where the L length is set to be L=6 μm in the first diode element and the second diode element.

FIG. 19A is a characteristics diagram illustrating in detail example characteristics on the charge side (first diode element) in the charge/discharge waveform illustrated in FIG. 18A, and FIG. 19B is a characteristics diagram illustrating in detail example characteristics on the charge side (first diode element) in the charge/discharge waveform illustrated in FIG. 18B.

FIG. 20A is a characteristics diagram illustrating in detail example characteristics on the discharge side (second diode element) in the charge/discharge waveform illustrated in FIG. 18A, and FIG. 19B is a characteristics diagram illustrating in detail example characteristics on the discharge side (second diode element) in the charge/discharge waveform illustrated in FIG. 18B.

FIGS. 21A and 21B are characteristics diagrams illustrating illuminance dependency in the case where the L length in the first diode element and the L length in the second diode element are configured so that the charge/discharge characteristics are equal to each other, in which FIG. 21A illustrates the charge/discharge characteristics in the case where the external light illuminance is 1700 lx, and FIG. 21B illustrates the charge/discharge characteristics in the case where the external light illuminance is 2600 lx.

FIGS. 22A and 22B are characteristics diagrams illustrating illuminance dependency in the case where the L length in the first diode element and the L length in the second diode element are configured so that the charge/discharge characteristics are equal to each other, in which FIG. 22A illustrates the charge/discharge characteristics in the case where the external light illuminance is 3600 lx, and FIG. 22B illustrates the charge/discharge characteristics in the case where the external light illuminance is 5600 lx.

FIG. 23A illustrates a first execution example of application program utilizing a detection result of the proximity object in the display device illustrated in FIG. 1, and FIG. 23B is an explanation view illustrating a second execution example.

FIG. 24 is an explanation view illustrating a third execution example of the application program utilizing the detection result of the proximity object.

FIG. 25 is an explanation view illustrating a fourth execution example of the application program utilizing the detection result of the proximity object.

FIG. 26 is an explanation view illustrating a fifth execution example of the application program utilizing the detection result of the proximity object.

FIG. 27 is a perspective view illustrating an appearance of a first application example of the display device illustrated in FIG. 1.

FIG. 28A is a perspective view illustrating an appearance as viewed from a front side of a second application example, and FIG. 28B is a perspective view illustrating an appearance as viewed from a rear side.

FIG. 29 is a perspective view illustrating an appearance of a third application example.

FIG. 30 is a perspective view illustrating an appearance of a fourth application example 4.

FIG. 31A is an elevation view of a fifth application example unclosed, FIG. 31B is a side view thereof, FIG. 31C is an elevation view of the fifth application example closed, FIG. 31D is a left side view thereof, FIG. 31E is a right side view thereof, FIG. 31F is a top face view thereof, and FIG. 31G is a bottom view thereof.

FIG. 32 is a characteristics diagram illustrating an example of a detection method of the proximity object in an existing display device with an input function.

FIG. 33 is a characteristics diagram illustrating another example of the detection method of the proximity object in the existing display device with the input function.

FIG. 34 is an example photographic view for explaining the existing detection method of the proximity object using a difference image.

### DETAILED DESCRIPTION

An example embodiment (hereinafter, simply referred to as an embodiment) will be described in detail below with reference to the accompanying drawings.

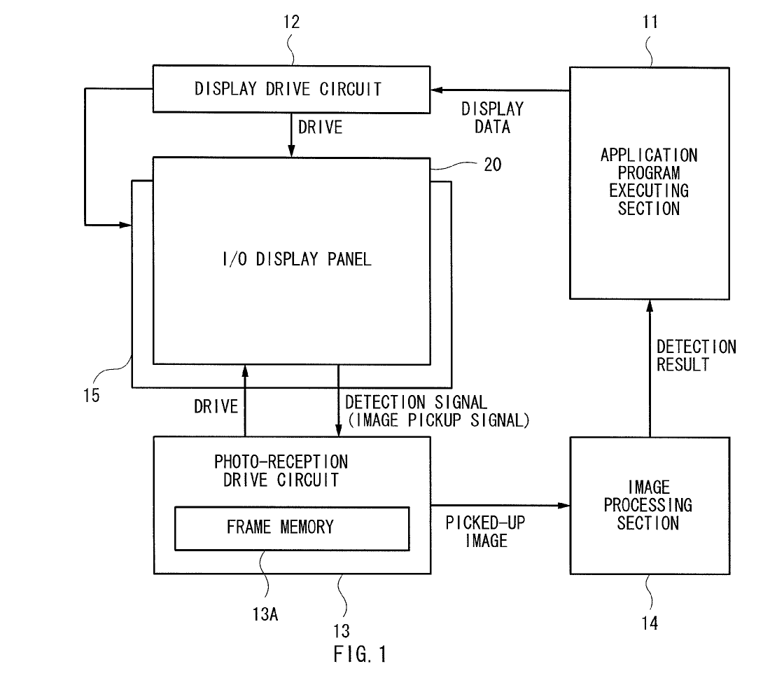

FIG. 1 illustrates an example of the overall structure of a display device with an input function (display and image pickup device) according to an example embodiment. This display device includes an I/O display panel 20, a backlight 15, a display drive circuit 12, a photo-reception drive circuit 13, an image processing section 14, and an application program executing section 11.

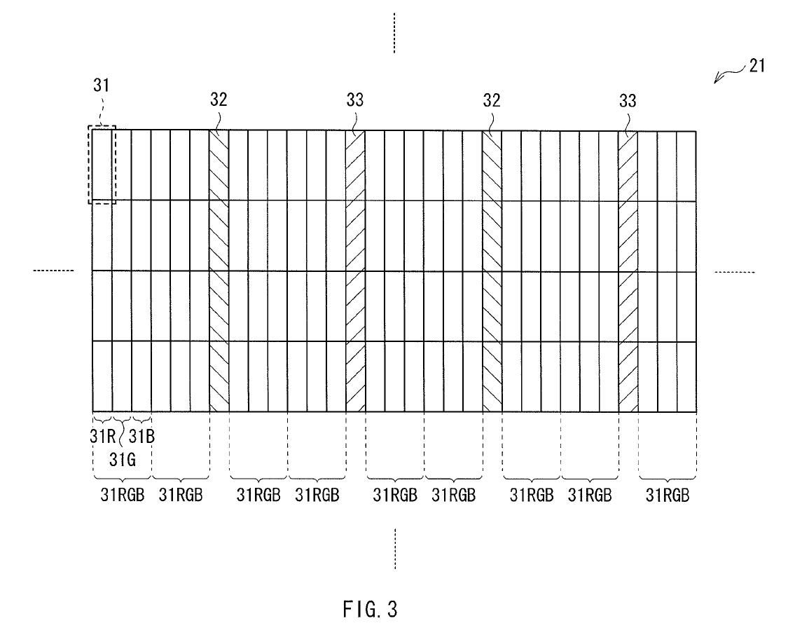

The I/O display panel 20 is formed of, for example, a liquid crystal display (LCD). In the I/O display panel 20, a plurality of display pixels 31RGB are arranged in matrix as illustrated in FIG. 3 which will be described later, and the I/O display panel 20 has a function (display function) displaying an image of a predetermined figure, a predetermined character, or the like based on display data while performing a line-sequential operation. Further, in the I/O display panel 20, a plurality of sensor elements 33 as image pickup pixels are arranged in matrix as illustrated in FIG. 3 which will be described later, and the I/O display panel 20 has a function (detection function and image pickup function) detecting and picking-up an image of an object (a proximity object, or an “external proximity object”) which is in contact with or is close to a panel surface.

The backlight 15 is a light source for display and detection of the I/O display panel 20, and, for example, a plurality of photo-emission diodes are arranged in the backlight 15. The backlight 15 is driven and controlled by the display drive circuit 12, and is capable of an on/off (light-on/light-off) operation at high speed at a predetermined timing in synchronization with an operation timing of the I/O display panel 20, as will be described later.

The display drive circuit 12 is a circuit driving the display pixels 31RGB of this I/O display panel 20 (driving the line-sequential display operation), so that an image based on the display data is displayed on the I/O display panel 20 (so that the display operation is performed). The display drive circuit 12 also performs the on/off (light-on and light-off) control of the backlight 15.

The photo-reception drive circuit 13 is a circuit driving the I/O display panel 20 (driving the line-sequential image pickup operation), so that a detection signal (image pickup signal) is obtained (so that the object is detected and the image is picked-up) from each sensor element (image pickup pixel) of the I/O display panel 20. The detection signal (image pickup signal) from each sensor element 33 is, for example, stored or accumulated in a frame memory 13A in a frame unit, and output as a detection image (picked-up image) to the image processing section 14.

The image processing section 14 performs a predetermined image process (calculation process) based on the picked-up image output from the photo-reception drive circuit 13. As a result of performing the image process, the image processing section 14 detects and obtains, for example, object information (position coordinate data, data of the shape and the size of the object, and the like) on the object which is close or the like to the I/O display panel 20.

The application program executing section 11 executes a process in response to predetermined application software based on the detection result obtained in the image processing section 14. As this process, for example, there is a process in which the display data includes the position coordinate of the detected object, and the display data is displayed on the I/O display panel 20 or the like. The display data generated in this application program executing section 11 is supplied to the display drive circuit 12.

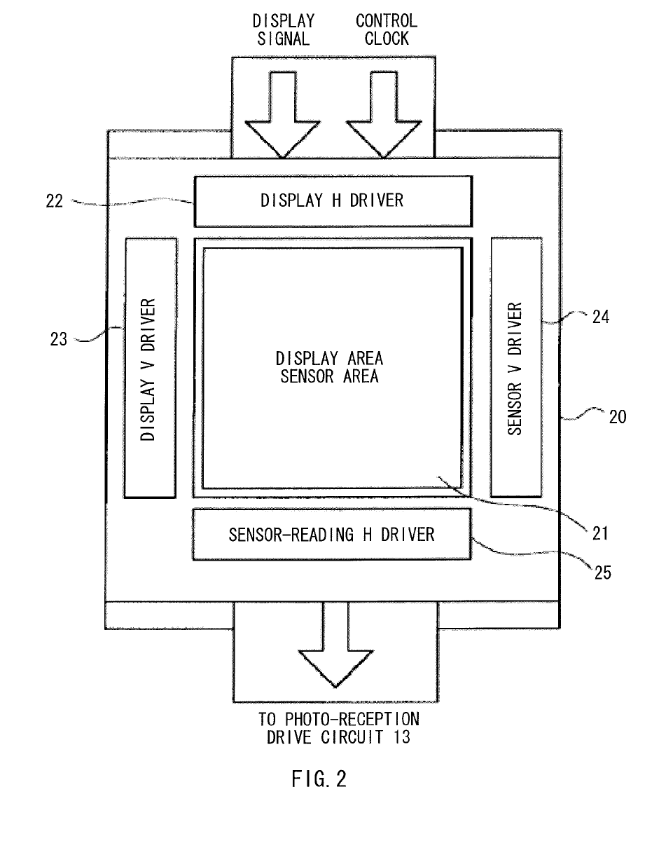

FIG. 2 illustrates a structure example of the I/O display panel 20. The I/O display panel 20 includes a display area (sensor area) 21, a display H driver 22, a display V driver 23, a sensor-reading H driver 25, and a sensor V driver 24.

In FIGS. 1 and 2, the photo-reception drive circuit 13, the sensor V driver 24, and the sensor-reading H driver 25 correspond to an illustrative example of “sensor driving section” of the example embodiment. The display drive circuit 12, the display H driver 22, and the display V driver 23 correspond to an illustrative example of “display driving section”. The I/O display panel 20 corresponds to an illustrative example of “display panel”. The backlight 15 corresponds to an illustrative example of “irradiation light source”. The photo-reception drive circuit 13 and the image processing section 14 correspond to an illustrative example of “signal processing section”.

The display area (sensor area) 21 is a region emitting irradiation light (including display light, and irradiation light for detection obtained from, for example, an infrared light source (not illustrated in the figure); the same applies hereinafter) by modulating the light from the backlight 15, and detecting (picking-up the image of) the object which is in contact with or close to this area. In the display area (sensor area) 21, for example, liquid crystal elements as the display pixels 31RGB, and sensor elements 33 which will be described later are arranged in matrix, respectively.

In cooperation with the display V driver 23, the display H driver 22 line-sequentially drives the display pixels 31RGB in the display area 21, based on a display signal for display drive and a control clock supplied from the display drive circuit 12.

In cooperation with the sensor V driver 24, the sensor-reading H driver 25 line-sequentially drives the sensor elements 33 as image pickup pixels in the display area 21 in response to the drive control by the photo-reception drive circuit 13, and obtains the detection signal (image pickup signal). When the irradiation light is irradiated from the backlight 15 to the proximity object, the photo-reception drive circuit 13 performs the drive control so that the electric charges are stored or accumulated in the sensor element 33 according to a total light amount of the reflection light caused by the irradiation light and the environmental light (external light) (i.e., a sum of an amount of external light and an amount of reflection light from the external proximity object). When the irradiation light is not irradiated from the backlight 15, the photo-reception drive circuit 13 performs the drive control so that the discharges (the electric charges) are released from the sensor element 33 according to the light amount of the environmental light. The sensor-reading H driver 25 outputs, to the photo-reception drive circuit 13, the detection signal (image pickup signal) from the sensor element 33 obtained by these drive controls.

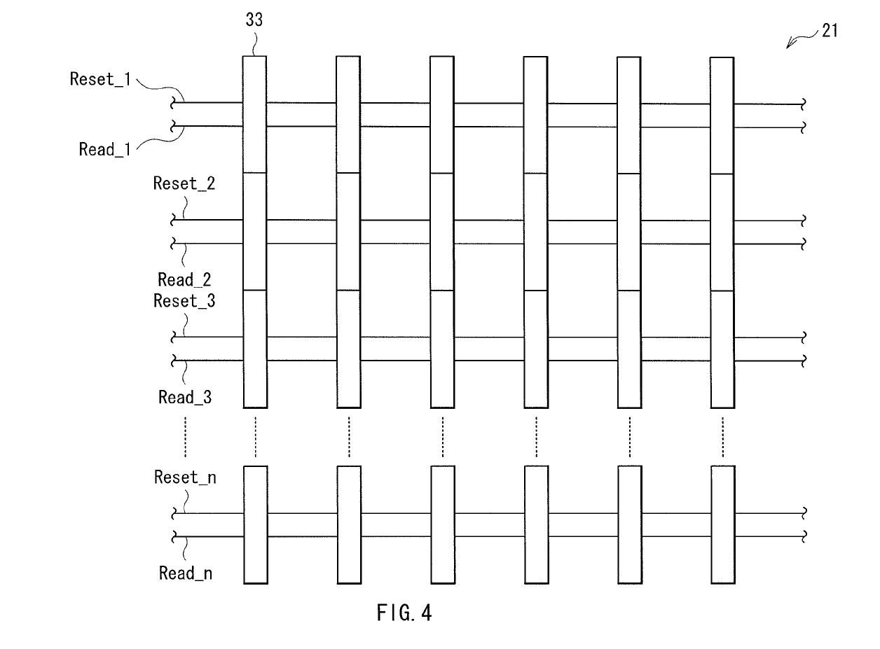

FIG. 3 illustrates a detailed structure example of each pixel in the display area (sensor area) 21. For example, as illustrated in FIG. 3, a pixel 31 of the display area 21 is configured of the display pixel 31RGB, the sensor element 33 as the image pickup pixel, and a wiring section 32 in which a wiring for the sensor element 33 is formed. The display pixel 31RGB is configured of a display pixel for red (R) 31R, a display pixel for green (G) 31G, and a display pixel for blue (B) 31B. These display pixels 31RGB, the sensor elements 33, and the wiring sections 32 are arranged side by side in matrix on the display area (sensor area), respectively. The sensor element 33, and the wiring section 32 for driving this sensor element 33 are arranged separately from each other at regular intervals. By such an arrangement, the sensor area formed of the sensor element 33 and the wiring section 32 becomes extremely difficult to be recognized relative to the display pixel 31RGB, and the reduction of the aperture ratio in the display pixel 31RGB is minimized. When the wiring section 32 is arranged in a region which is not contributed to the aperture of the display pixel 3RGB (for example, a region shielded by a black matrix, a reflection region, or the like), it is possible to arrange a photo-reception circuit without reducing the display quality. For example, as illustrated in FIG. 4, reset signal lines Reset_1 to Reset_n, and read signal lines Read_1 to Read_n are connected to each sensor element 33 along the horizontal line direction.

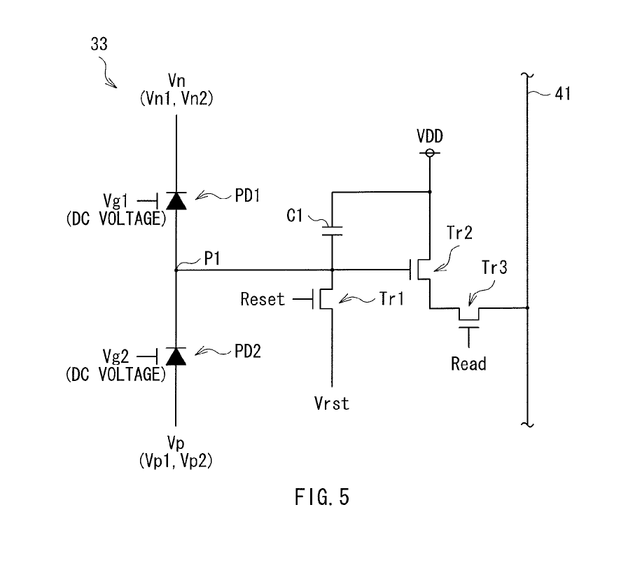

For example, as illustrated in FIG. 5, the sensor element 33 is configured of a first diode element PD1, a second diode element PD2, a capacitor C1 as a capacitive element, a first transistor Tr1, a second transistor Tr2, and a third transistor Tr3.

The first diode element PD1 and the second diode element PD 2 are each a photoelectric conversion element generating electric charges in accordance with the incident light amount. In particular, the first diode element PD1 generates charges in accordance with the incident light amount, and the second diode element PD2 generates discharges in accordance with the incident light amount. As will be described later, the first diode element PD1 and the second diode element PD2 are each configured of a PIN type photodiode. The PIN type photodiode includes a p-type semiconductor region, an n-type semiconductor region, and an intrinsic semiconductor region (i-region) formed between the p-type semiconductor region and the n-type semiconductor region. The first diode element PD1 includes an anode electrode, a cathode electrode, and a gate electrode. Likewise, the second diode element PD2 includes an anode electrode, a cathode electrode, and a gate electrode. In the case where the first diode element PD1 and the second diode element PD2 are each configured of the PIN type photodiode, the anode electrode is connected to the p-type semiconductor region, and the cathode electrode is connected to the n-type semiconductor region. A detailed example of the element structure will be described later.

The anode electrode of the first diode element PD1 and the cathode electrode of the second diode element PD2 are connected to each other, and thereby the first diode element PD1 and the second diode element PD2 are connected in series to each other. One end of the capacitor C1 is connected to a connection point (i.e., a junction) P1 of the first diode element PD1 and the second diode element PD2. The other end of the capacitor C1 is connected to a power source VDD.

The first transistor Tr1 to a third transistor to Tr3 are each configured of, for example, a thin film transistor (TFT) or the like. A gate of the first transistor Tr1 is connected to the reset signal line Reset (refer to FIG. 4), and a source of the first transistor Tr1 is connected to a reset power source Vrst. A drain of the first transistor Tr1, a gate of the second transistor Tr2, and one end of the capacitor C1 are connected to the connection point P1 of the first diode element PD1 and the second diode element. A source of the second transistor Tr2, and the other end of the capacitor C1 are connected to the power source VDD. A drain of the second transistor Tr2 is connected to a drain of the third transistor Tr3. A gate of the third transistor Tr3 is connected to the read signal line Read, and a source of the third transistor Tr3 is connected to a read line 41. The reset power source Vrst is set to have a voltage (reset voltage) by which the electric charges stored or accumulated in the capacitor C1 in the sensor element 33 are all released.

In this sensor element 33, the first diode element PD1 is in the on state, and the second diode element is in the off state, and thereby the charges generated in the first diode element PD1 are stored in the capacitor C1. The second diode element is in the on state, and the first diode element PD1 is in the off state, and thereby the discharges generated in the second diode element PD2 are released from the capacitor C1. The photo-reception drive circuit 13 individually performs the on/off control of the first diode element PD1 and the second diode element PD2, so that such a storage operation and such a discharge operation are alternately performed.

The on/off control of the first diode element PD1 is performed by changing the potential relationship between the cathode electrode and the gate electrode, and the on/off control of the second diode element PD2 is performed by changing the potential relationship between the anode electrode and the gate electrode, respectively. For example, as will be described later, in the first diode element PD1, the on/off control is performed by changing a cathode voltage Vn to be Vn1 and Vn2 in the state where a gate voltage Vg1 is a fixed voltage. For example, in the second diode element PD2, the on/off control is performed by changing an anode voltage Vp to be Vp1 and Vp2 in the state where a gate voltage Vg2 is a fixed voltage.

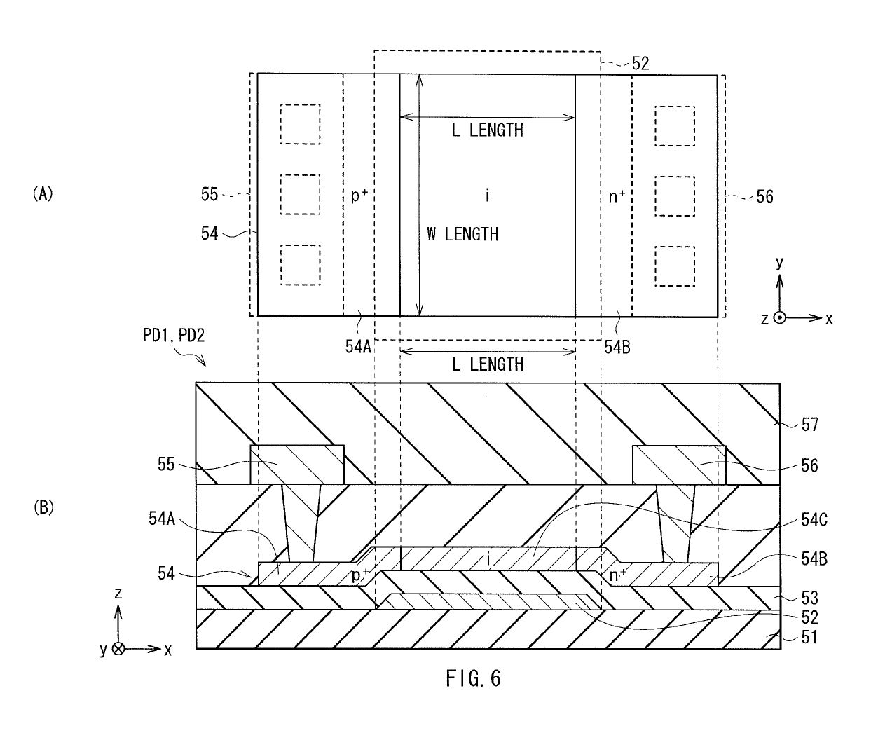

Part (A) and part (B) of FIG. 6 illustrate an example of the element structure of the first diode element PD1 and the second diode element PD2. The first diode element PD1 and the second diode element PD2 basically have the same structures except that the L length of the first diode element PD1 and the L length of the second diode element are different from each other, and the W length of the first diode element PD1 and the W length of the second diode element are different from each other, as will be described later. The first diode element PD1 and the second diode element PD2 are configured of PIN type photodiodes. In part (A) and part (B) of FIG. 6, a structure example of the bottom gate type is illustrated, and the first diode element PD1 and the second diode element PD2 each include a gate electrode 52, a gate insulating film 53, a semiconductor layer 54, an anode electrode 55, a cathode electrode 56, and an insulating film 57 which are formed on a substrate 51. The semiconductor layer 54 includes a p-type semiconductor region 54A, an n-type semiconductor region 54B, and an intrinsic semiconductor region (i-region) 54C formed between the p-type semiconductor region 54A and the n-type semiconductor region 54B.

The substrate 51 is, for example, an insulating substrate such as a plastic film substrate and a glass substrate. The gate electrode 52 is configured of, for example, aluminum (Al). The gate electrode 52 is formed at least in a region facing or opposing the intrinsic semiconductor region 54C, and has, for example, a rectangular shape. In part (A) and part (B) of FIG. 6, the case where the gate electrode 52 is formed not only in a region facing or opposing the intrinsic semiconductor region 54C, but also in a region facing or opposing a portion including a part of the p-type semiconductor region 54A and a part of the n-type semiconductor region 54B is illustrated. Thereby, the gate electrode 52 is an electrode having the low resistance, and serves as a light shielding film shielding the light which is incident on the intrinsic semiconductor region 54C from the substrate 51 side.

The gate insulating film 53 contains, for example, silicon oxide (SiO₂), silicon nitride (SiN), and the like as major components. The gate insulating film 53 opposes the semiconductor layer 54 in the stacking direction (z direction in the figure). The gate insulating film 53 is, for example, formed at least in a region facing or opposing a portion including the intrinsic semiconductor region 54C, and is formed, for example, so as to cover the gate electrode 52. In part (A) and part (B) of FIG. 6, the case where the gate insulating film 53 is formed over the whole surface of the substrate 51 including the gate electrode 52 is illustrated.

The semiconductor layer 54 is formed so as to intersect a region facing or opposing the gate electrode 52, and is formed so as to extend in the facing (opposing) direction (x direction in the figure) of the anode electrode 55 and the cathode electrode 56. The top face of the semiconductor layer 54 is covered by the insulating film 57 except a contact portion of the anode electrode 55 and the cathode electrode 56. The external light is incident on the semiconductor layer 54 from the top face side of the insulating film 57. The insulating film 57 is made of a material transparent to the incident light, and contains, for example, silicon oxide (SiO₂), silicon nitride (SiN), and the like as major components. The substrate 51 is, for example, an insulating substrate such as a plastic film substrate and a glass substrate. The gate electrode 52 is configured of, for example, aluminum (Al). The gate electrode 52 is formed at least in a region facing or opposing the intrinsic semiconductor region 54C, and has, for example, a rectangular shape. In part (A) and part (B) of FIG. 6, the case where the gate electrode 52 is formed not only in a region facing or opposing the intrinsic semiconductor region 54C, but also in a region facing or opposing a portion including a part of the p-type semiconductor region 54A and a part of the n-type semiconductor region 54B is illustrated. Thereby, the gate electrode 52 is an electrode having the low resistance, and serves as a light shielding film shielding the light which is incident on the intrinsic semiconductor region 54C from the substrate 51 side.

The p-type semiconductor region 54A and the n-type semiconductor region 54B oppose each other in a first direction (x direction in the figure) in a stack plane (in an x-y plane in the figure). The p-type semiconductor region 54A and the n-type semiconductor region 54B are not in direct contact with each other, and arranged with the intrinsic semiconductor region 54C in between. Thus, in the semiconductor layer 54, for example, a PIN structure is formed in the plane direction. The p-type semiconductor region 54A is, for example, formed of a silicon thin film containing a p-type impurity (p⁺), and the n-type semiconductor region 54B is, for example, formed of a silicon thin film containing an n-type impurity (n⁺). The intrinsic semiconductor region 54C is, for example, formed of a silicon thin film in which an impurity is undoped.

The anode electrode 55 and the cathode electrode 56 are, for example, configured of aluminum (Al). The anode electrode 55 is electrically connected to the p-type semiconductor region 54A, and the cathode electrode 56 is electrically connected to the n-type semiconductor region 54B.

In this sensor element 33, the length (so-called L length) in the first direction (x direction in the figure) of the intrinsic semiconductor region 54C in the first diode element PD1, and the length in the first direction of the intrinsic semiconductor region 54C in the second diode element PD2, are different from each other. Specifically, the following Condition (1) is satisfied, where the L length in the first diode element PD1 is L1, and the L length in the second diode element PD2 is L2. Thereby, the difference of the response characteristics (a time constant τ indicating the current response characteristics when the off state is shifted to the on state) between the two diode elements PD1 and PD2 becomes structurally small.

L2<L1 (1)

Further, the length (so-called W length) in a second direction (y direction in the figure) of the intrinsic semiconductor region 54C in the first diode element PD1, and the length in the second direction of the intrinsic semiconductor region 54C in the second diode element PD2, are preferably different from each other (the second direction is orthogonal to the first direction in the stack plane). Specifically, the following Condition (2) is preferably satisfied, where the W length in the first diode element PD1 is W1, and the W length in the second diode element PD2 is W2.

L2·W2=L1·W1 (2)

Theoretically, the Condition (2) is an ideal condition, and it is not always necessary that the value of L2·W2 and the value of L1·W1 be perfectly matched. From a practical viewpoint, it is appropriate when the value of L2·W2 and the value of L1·W1 are substantially matched within a range that issues do not occur in the detection characteristics of the sensor element 33. Also, the difference of the values may be existed in a degree of manufacture error. Since the area of the intrinsic semiconductor regions 54C in the first diode elements PD1 and the area of the intrinsic semiconductor region 54C in the second diode element PD2 are equal to each other by satisfying the Condition (2), the response characteristics are coincident with each other between the first diode element PD1 and the second diode element PD2 by satisfying the Condition (1), and the magnitudes of the photocurrents generated by the charge/discharge are equal to each other between the first diode element PD1 and the second diode element PD2.

The film thickness (length in the z direction) of the intrinsic semiconductor region 54C in the first diode element PD1 and the film thickness of the intrinsic semiconductor region 54C in the second diode element PD2 are preferably substantially equal to each other. Due to the manufacture process, although it is relatively easy to change the L length and the W length of the first diode element PD1 and those of the second diode element PD2, it is not practical to individually change the film thickness.

Next, outline of the display operation of the image and the detection operation (image pickup operation) of the object in the display device will be described.

In this example display device, based on the display data supplied from the application program executing section 11, a display drive signal is generated in the display drive circuit 12. By this drive signal, the line-sequential display drive is performed on the I/O display panel 20, and the image is displayed. At this time, the backlight 15 is driven by the display drive circuit 12, and the light-on/light-off operation is performed in synchronization with the operation of the I/O display panel 20.

In the case where there is the object (proximity object such as a finger) which is in contact with or close to the I/O display panel 20, by the line-sequential image pickup drive by the photo-reception drive circuit 13, that object is detected (image is picked up) in each sensor element (image pickup pixel) 33 in the I/O display panel 20. The detection signal (image pickup signal) from each sensor element 33 is supplied from the I/O display panel 20 to the photo-reception drive circuit 13. The detection signal of one frame supplied from the sensor element 33 is stored in the photo-reception drive circuit 13, and is output as the picked-up image to the image processing section 14.

In the image processing section 14, by performing a predetermined image process (calculation process) based on this picked-up image, the object information (the position coordinate data, the data about the shape and the size of the object, and the like) on the object which is in contact with or close to the I/O display panel 20 is obtained. For example, the calculation process is performed to determine the center of gravity of the picked-up image of one frame generated in the photo-reception circuit 13, and the center of contact (or proximity) is specified. The detection result of the proximity object is then output from the image processing section 14 to the application program executing section 11. In the application program executing section 11, the application program which will be described later is executed.

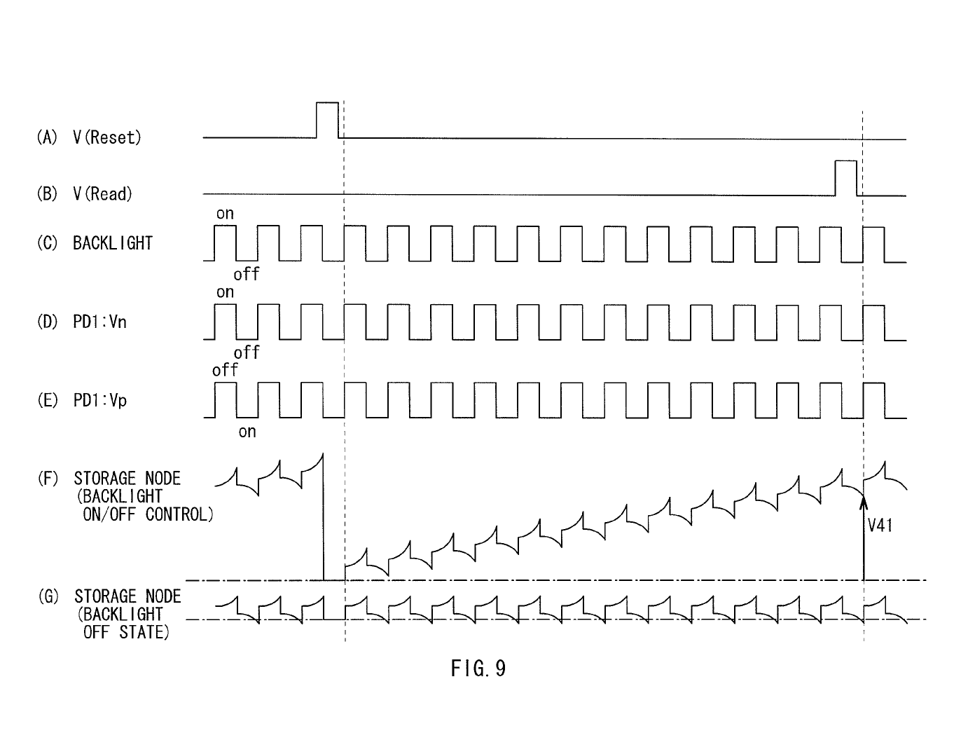

Next, with reference to FIGS. 9 to 11, the detection operation (image pickup operation) in this display device will be described in detail. Part (A) to part (G) of FIG. 9 illustrate an example of the detection operation (detection and image pickup operation in one sensor element 33) in this display device in a form of a timing waveform diagram. Part (A) of FIG. 9 illustrates an example of the timing waveform of a reset signal voltage V (Reset), and part (B) of FIG. 9 illustrates an example of the timing waveform of a read signal voltage V (Read). Part (C) of FIG. 9 illustrates an example of the timing waveform where the backlight 15 is in the on/off (light-on/light-off) (irradiation/unirradiation of irradiation light for detection) state. Part (D) of FIG. 9 illustrates an example of the timing waveform of the cathode voltage Vn of the first diode element PD1 in the sensor element 33 (substantially, the timing waveform where the first diode element PD1 is in the on/off state). Part (E) of FIG. 9 illustrates an example of the timing waveform of the anode voltage Vp of the second diode element PD2 (substantially, the timing waveform where the second diode element PD2 in the on/off state). Part (F) of FIG. 9 illustrates an example of the timing waveform of the potential (storage voltage) generated in the connection point (storage node, or accumulation node) P1 in the sensor element 33 when the on/off control of the backlight 15 is performed as in part (C) of FIG. 9. Part (G) of FIG. 9 illustrates the storage voltage of the storage node P1 in the case where the backlight 15 is in the off state in all the periods (unlike the on-off control as in part (C) of FIG. 9), and the reflection Lon from the proximity object is not present.

The reset signal voltage V (Reset) and the read signal voltage V (Read) illustrated in part (A) and part (B) of FIG. 9 become an H (high) state by the line-sequential operation, respectively. In the I/O display panel 20, in the sensor elements 33 on each horizontal line, the period from when the reset signal voltage V (Reset) becomes the H state to when the read signal voltage V (Read) becomes the H state is an exposure period of one horizontal line. In this exposure period, as illustrated in part (C) to part (E) of FIG. 9, the on state (light-on) and the off state (light-off) of the backlight 15 is alternately switched in synchronization with the on/off state of the first diode element PD1 and the second diode element PD2 in each sensor element 33. Specifically, when the backlight 15 is in the on state, the first diode element PD1 is in the on state, and the second diode element PD2 is in the off state. When the backlight 15 is in the off state, the first diode element PD1 is in the off state, and the second diode element PD2 is in the on state.

For example, when the reset signal voltage V (Reset) becomes the H state, the first transistor Tr1 in the sensor element 33 becomes the on state, and thereby the potential of the connection point P1 is reset to be the reset voltage Vrst which is optionally set.

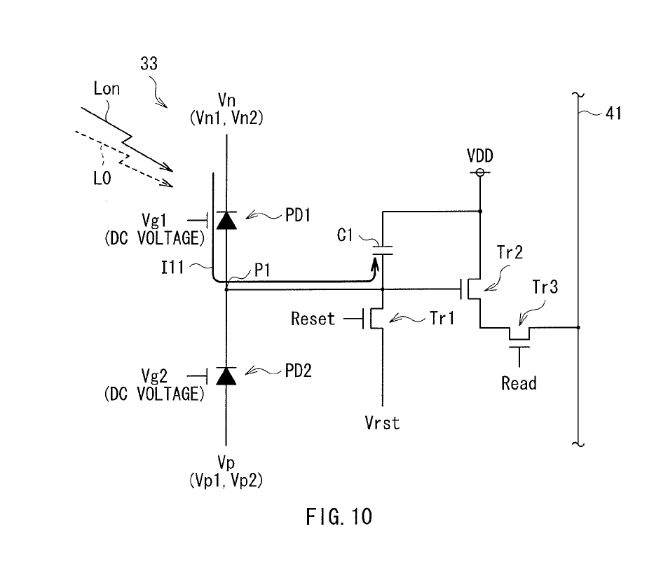

After the reset operation by the reset voltage Vrst, the backlight 15 becomes the on state. At this time, the first diode element PD1 is in the on state and the second diode element PD2 is the off state, and thus the storage operation (charge operation) of the charges to the capacitor C1 is performed. Thereby, in accordance with the total light amount of the reflection light Lon irradiated from the backlight 15 and then reflected by the proximity object, and the external light (environmental light) L0, the charges are stored in the capacitor C1 through a path of a charge current I11 illustrated in FIG. 10, and the storage voltage is increased as illustrated in part (F) of FIG. 9.

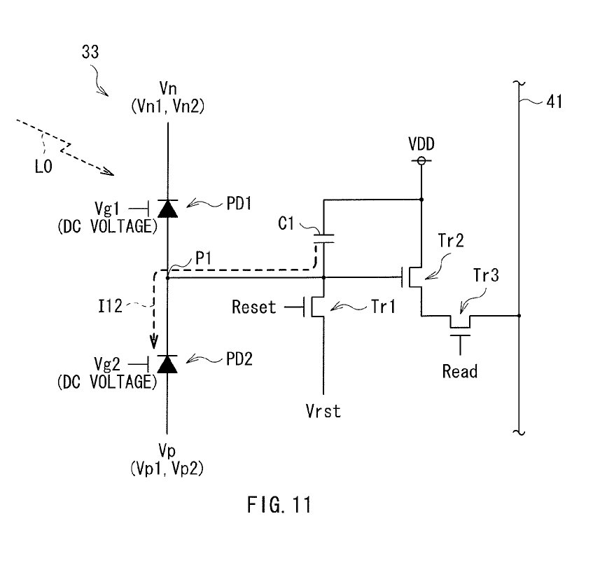

Next, the backlight 15 becomes the off state. At this time, the first diode element PD1 is in the off state and the second diode element PD2 is the on state, and thus the release operation (discharge operation) of the discharges from the capacitor C1 is performed. Thereby, in accordance with the light amount of the external light (environmental light) L0, the discharges are released from the capacitor C1 through a path of a charge current I12 illustrated in FIG. 11, and the storage voltage is reduced as illustrated in part (F) of FIG. 9.

After such a storage operation of the charges and such a release operation of the discharges are switched for a plurality of times during the predetermined exposure period, the electric charges stored in the capacitor C1 during that period are read as the detection signal (image pickup signal). Specifically, when the read signal voltage V (Read) becomes the H state, the third transistor Tr3 in the sensor element 33 thereby becomes the on state, and a read voltage V41 illustrated in part (F) of FIG. 9 is read from a read line 41. In this manner, after the storage operation of the charges and the release operation of the discharges are switched for the plurality of times, the detection signal is read. Thereby, the exposure period becomes long, and the signal component (storage voltage) of the detection signal is increased as illustrated in part (F) of FIG. 9. Since the image pickup signal obtained here has the analogue value, the A/D (analogue/digital) conversion is performed in the photo-reception drive circuit 13. After that, the reset signal voltage V (Reset) becomes the H state again, and the same operation is repeated hereinafter.

In this manner, in the detection process of the proximity object in this example embodiment, when the irradiation light from the backlight 15 is irradiated to the proximity object, the charges are stored in each sensor element 33 in accordance with the total light amount of the reflection light Lon caused by the irradiation light, and the environmental light (external light) L0. When the irradiation light is not irradiated, the discharges are released from each sensor element 33 in accordance with the light amount of the environmental light L0. Thereby, the detection signal (image pickup signal) is obtained from each sensor element 33. By using the picked-up image based on the image pickup signal obtained from each sensor element 33, the object information including at least one of the position, the shape, and the size of the proximity object is obtained in the image processing section 14. Thereby, the component of the environmental light L0 is subtracted from the image pickup signal obtained in each sensor element 33, and it is possible to obtain the object information of the proximity object without being influenced by such an environmental light L0.

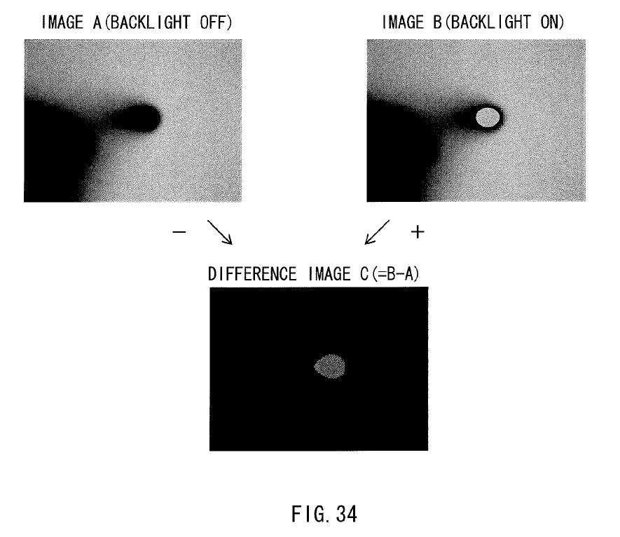

Also, since the image pickup signal is obtained for each sensor element 33 based on the storage operation of the charges and the release operation of the discharges, in the photo-reception drive circuit 13, it is possible to reduce the number of frame memories 13A necessary for generating the picked-up image from the image pickup signal, in comparison with the existing technique. For example, in an example of the existing technique illustrated in FIG. 34, frame memories are necessary for two images which are an image (image A) when the backlight is in the off state, and an image (image B) when the backlight is in the on state. On the other hand, in the display device of this embodiment, the image memory of one frame is enough. Thus, it is possible to stably detect the object regardless of the use situation while suppressing the manufacture cost.

Further, since the objection information is obtained based on the image pickup signal obtained after the storage operation of the charges and the release operation of the discharges are switched for the plurality of times, it is possible to make the exposure time long. Thereby, since the detection sensitivity is improved by increasing the signal component (storage potential VP1) of the image pickup signal and the exposure time is freely set, it is possible to increase a S/N ratio.

In the detection process of the proximity object in this embodiment, the object information not only on one proximity object, but also on each of a plurality of proximity objects arranged at the same time on the display area 21 of the I/O display panel 20 is similarly obtained.

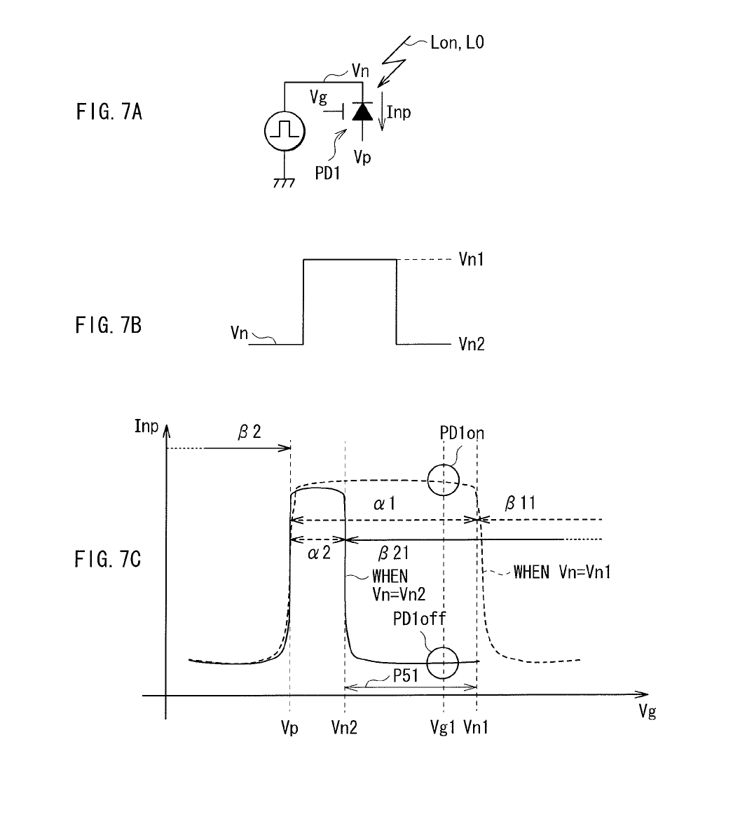

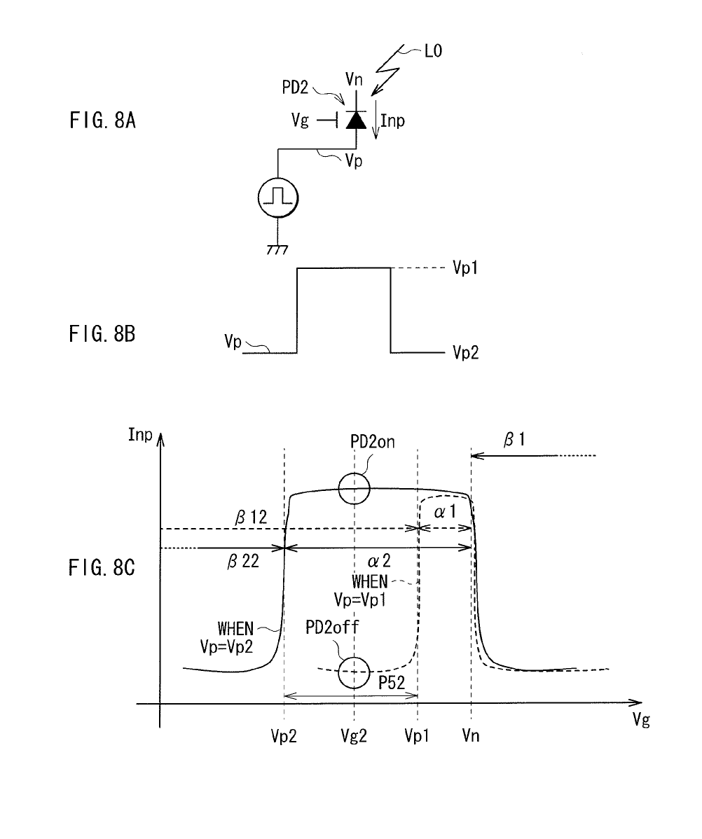

With reference to FIGS. 7A to 7C and FIGS. 8A to 8C, the control of the on/off state of the first diode element PD1 and the second diode element PD2 in the sensor element 33 will be described in detail. As illustrated in FIGS. 7A and 8A, in the first diode element PD1 and the second diode element PD2, the anode voltage is Vp, the cathode voltage is Vn, the gate voltage is Vg, and the photocurrent flowing from the cathode to the anode is Inp.

In the first diode element PD1, the on/off state is controlled by applying a rectangular wave as the cathode voltage Vn, which is alternately varied between Vn1 and Vn2 as illustrated in FIG. 7B in the state where the gate voltage Vg is set to be a fixed voltage Vg1. FIG. 7C illustrates I-V characteristics in the first diode element PD1 in both Vn1 and Vn2 in the case where the cathode voltage Vn is varied between Vn1 and Vn2 (refer to arrow P51 in FIG. 7C; Vn2<Vn1). In FIG. 7C, α1 and α2 are on operation regions where the first diode element PD1 becomes the on state. β2, β21, and β11 are off operation regions where the first diode element PD1 becomes the off state. As illustrated in FIG. 7C, the voltage range of the on operation region when Vn=Vn1, and the voltage range of the on operation region when Vn=Vn2 are different from each other, and the voltage range of the off operation region when Vn=Vn1, and the voltage range of the off operation region when Vn=Vn2 are different from each other. In FIG. 7C, when Vn=Vn1, the voltage range of α1 is the on operation region, and when Vn=Vn2, the voltage range of α2 is the on operation region. In FIG. 7C, when Vn=Vn1, the voltage ranges of β2 and β11 are the off operation regions, and when Vn=Vn2, the voltage ranges of β2 and β21 are the off operation regions. Due to such characteristics, when the gate voltage Vg is equal to Vg1 and the cathode voltage Vn is equal to Vn1, the first diode element PD1 becomes the on state (operation point PD1on in FIG. 7C). When the gate voltage Vg is equal to Vg1 and the cathode voltage Vn is equal to Vn2, the first diode element PD1 becomes the off state (operation point PD1off in FIG. 7C).

In the second diode element PD2, the on/off state is controlled by applying a rectangular wave as the anode voltage Vp, which is alternately varied between Vp1 and Vp2 as illustrated in FIG. 8B in the state where the gate voltage Vg is set to be a fixed voltage Vg2. FIG. 8C illustrates I-V characteristics in the second diode element PD2 in both Vp1 and Vp2 in the case where the anode voltage Vp is varied between Vp1 and Vp2 (refer to arrow P52 in FIG. 8C; Vp2<Vp1). In FIG. 8C, α1 and α2 are the on operation regions where the second diode element PD2 becomes the on state. β1, β12, and β22 are the off operation regions where the second diode element PD2 becomes the off state. As illustrated in FIG. 8C, the voltage range of the on operation region when Vp=Vp1, and the voltage range of the on operation region when Vp=Vp2 are different from each other, and the voltage range of the off operation region when Vp=Vp1, and the voltage range of the off operation region when Vp=Vp2 are different from each other. In FIG. 8C, when Vp=Vp1, the voltage range of α1 is the on operation region, and when Vp=Vp2, the voltage range of α2 is the on operation region. In FIG. 8C, when Vp=Vp1, the voltage ranges of β1 and β12 are the off operation regions, and when Vp=Vp2, the voltage ranges of β1 and β22 are the off operation regions. Due to such characteristics, when the gate voltage Vg is equal to Vg2 and the cathode voltage Vp is equal to Vp2, the second diode element PD2 becomes the on state (operation point PD2on in FIG. 8C). When the gate voltage Vg is equal to Vg1 and the cathode voltage Vp is equal to Vp1, the second diode element PD2 becomes the off state (operation point PD2off in FIG. 8C).

As described above, in the sensor element 33 of this example embodiment, the on/off control of the first diode element PD1 and the second diode element PD2 are performed by the separate control voltages, and the charge operation and the discharge operation are alternately repeated. Thereby, the detection of the proximity object is performed. In this case, as will be described below, when there is the difference in the response characteristics (transient characteristics) between the first diode element PD1 and the second diode element PD2, it is difficult to perform the favorable detection operation. In this embodiment, to improve this, the L length and the W length (refer to FIG. 6) of the intrinsic semiconductor region 54 in the first diode element PD1, and the L length and the W length of the intrinsic semiconductor region 54 in the second diode element PD2 are optimized.

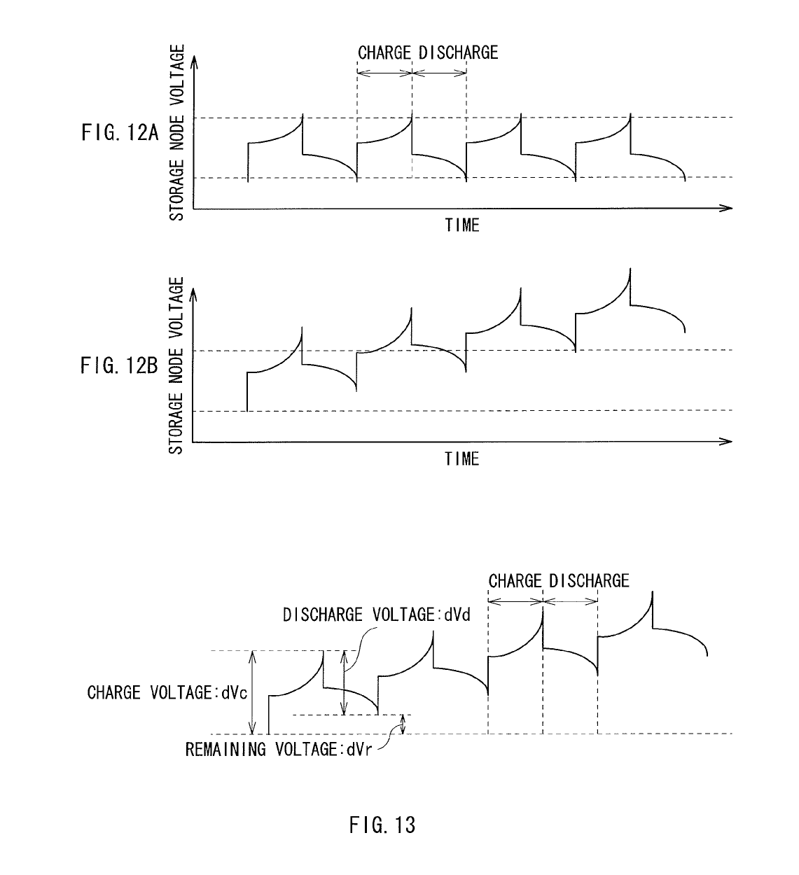

First, an issue generated in the case where there is the difference in the response characteristics will be described with reference to FIGS. 12A, 12B, and 13. FIG. 12A illustrates the voltage waveform of the storage node (connection point P1 of FIG. 5) when there is no difference in the response characteristics, and the first diode element PD1 and the second diode element PD2 are operated in the ideal state in the sensor element 33. In FIG. 12A, similarly to part (G) of FIG. 9, the voltage waveform in the case where the backlight 15 is in the off state during all the periods, and the reflection light L0 from the proximity object is not present (the case only the external light component is present) is illustrated. In the detection process of the proximity object in this embodiment, as illustrated in FIG. 10, when the irradiation light from the backlight 15 is irradiated to the proximity object, the charges are stored in the sensor element 33 in accordance with the total light amount of the reflection light Lon caused by the irradiation light, and the environmental light (external light) L0. As illustrated in FIG. 11, when the irradiation light is not irradiated, the discharges are released from the sensor element 33 in accordance with the light amount of the environmental light L0. Thereby, when the charge operation and the discharge operation are performed, since the component by the environmental light L0 is subtracted, only the voltage in accordance with the reflection light Lon from the proximity object is detected as the difference. Thus, in the case where the reflection light Lon is not present, theoretically, when one charge operation and one discharge operation are performed, the voltage obtained as the difference is zero. In this case, as illustrated in FIG. 12A, the voltage of the storage node theoretically and ideally has the waveform in which the charge amount of the electric charges obtained by the charge operation, and the discharge amount of the electric charges obtained by the discharge operation are equal to each other.

FIG. 12B illustrates the voltage waveform of the storage node in the case where there is the difference in the response characteristics between the first diode element PD1 and the second diode element PD2. In FIG. 12B, similarly to FIG. 12A, the voltage waveform in the case where the reflection light L0 from the proximity object is not present is illustrated. Although the reflection light L0 is not present, the charging is performed in the storage node when the charge operation and the discharge operation are repeated, and the voltage is gradually increased. This means that the charge capability by the first diode element PD1 is higher than the discharge capability by the second diode element PD2, and the charging is performed in the storage node as a whole. Such a state may cause malfunction in the sensor element 33, which is unpreferable.

The voltage waveform as in FIG. 12B is observed in the case where the first diode element PD1 and the second diode element PD2 have completely the same structures as each other, in particular, in the case where the L length and the W length of the intrinsic semiconductor region 54C in the first diode element PD1, and the L length and the W length of the intrinsic semiconductor region 54C in the second diode element PD2 are equal to each other. As will be described later, in the case where the L length in the first diode element PD1 and the L length in the second diode element PD2 are equal to each other, the saturation rate of the photocurrents (current time constant τ) are different from each other between the first diode element PD1 at the time of the charge operation and the second diode element PD2 at the time of the discharge operation, and there are the characteristics that the current time constant τ in the first diode element PD1 is smaller than that in the second diode element PD2. Thereby, the charge amount by the first diode element PD1 exceeds the discharge amount by the second diode element PD2. In this case, as illustrated in FIG. 13, the difference between the charge voltage dVc and the discharge voltage dVd is stored or accumulated as a remaining voltage dVr, and this results in an external light noise component at the time of the detection process.

Next, the relationship between the L length and the response characteristics (current time constant τ) will be described.

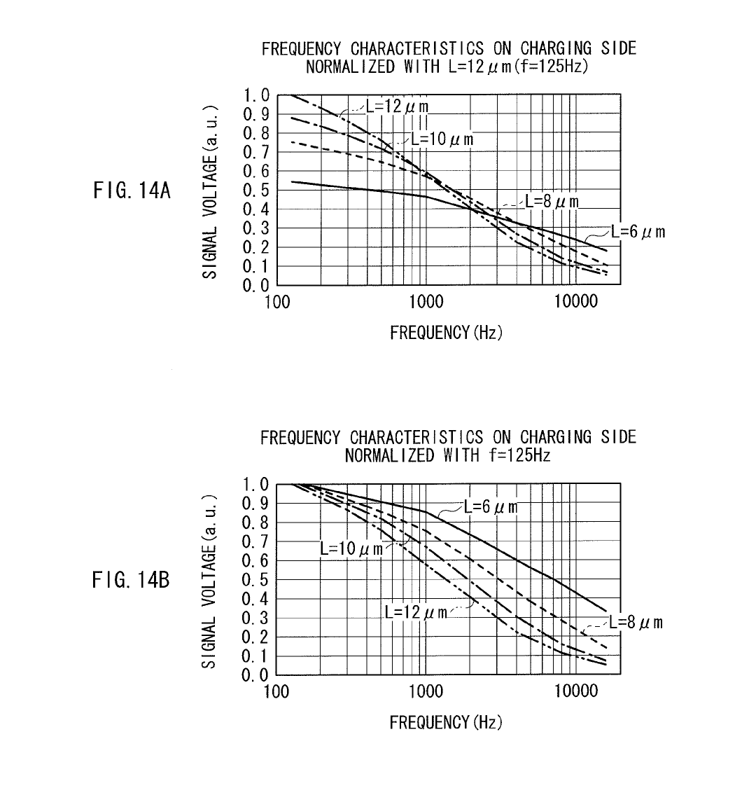

FIGS. 14A and 14B illustrate the frequency characteristics (actual measurement values) due to the difference in the L length (L=6 μm, 8 μm, 10 μm, and 12 μm) in the first diode element PD1. The horizontal axis indicates a frequency (Hz), and the vertical axis indicates a signal voltage (voltage at the time of the charge operation) of an arbitrary unit (a. u.). The frequency described here means the drive frequency (on/off frequency) of the first diode element PD1. FIG. 14A illustrates the frequency characteristics normalized by the signal voltage of 1 (one) when the L length is L=12 μm and the frequency is 125 Hz. FIG. 14B illustrates the frequency characteristics normalized by the signal voltage of 1 (one) when the frequency is 125 Hz in each L length. As seen from FIG. 14A, when the drive frequency is low, as the L length is longer, the signal voltage is higher. When the drive frequency is high, as the L length is shorter, the signal voltage is higher. As the L length is shorter, the signal reduction in the high frequency is smaller.

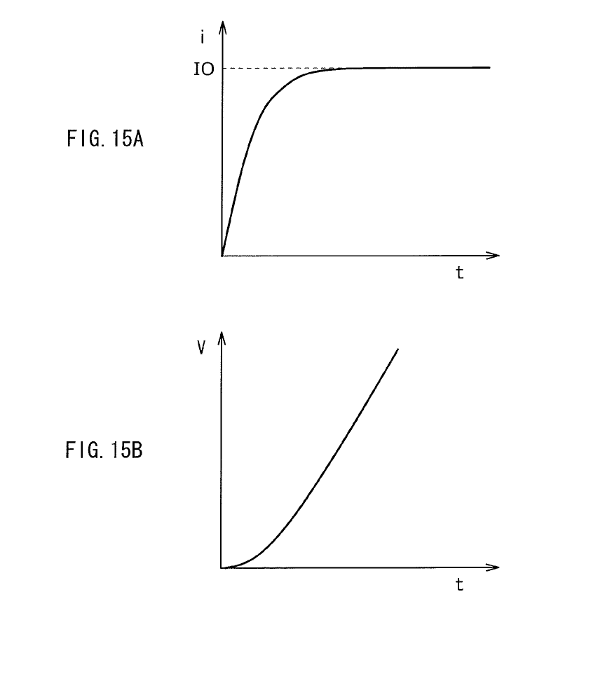

Here, it is considered to reproduce the frequency characteristics using the actual measurement values illustrated in FIG. 14A with a calculation formula. As in FIG. 15A, it is assumed that a current “i” rises to reach a saturation current I0 at the current time constant τ as a time “t” elapses. FIG. 15A is represented by Formula (A) by using an exponential function. An electric charge amount (idt) after the elapse of the time “t” is represented by Formula (B).

$$\begin{matrix}i = {I}_{0} \cdot ( 1 - {e}^{- \frac{t}{τ}} ) \\ i = {I}_{0} \cdot ( 1 - {e}^{- \frac{t}{τ}} ) & ( A ) \\ \begin{matrix}i d t = {I}_{0} \cdot {\int }_{0}^{t} ( 1 - {e}^{- \frac{t}{τ}} ) d t \\ = {I}_{0} \cdot {[ t + τ \cdot {e}^{- \frac{t}{τ}} ]}_{0}^{t} \\ = {I}_{0} \cdot ( t + τ \cdot {e}^{- \frac{t}{τ}} - τ )\end{matrix} & ( B )\end{matrix}$$

Accordingly, from the Formula (B) above, the voltage waveform of the storage node P1 (refer to FIG. 5) is represented by following Formula (II). In the Formula (II), “C” represents parasitic capacity in the storage node P1. “f” represents the drive frequency. This is indicated by a graph of FIG. 15B.

$$V = \frac{{I}_{0}}{C} \cdot ( t + τ \cdot {e}^{- \frac{t}{τ}} - τ ) \cdot f \qquad ( 11 )$$

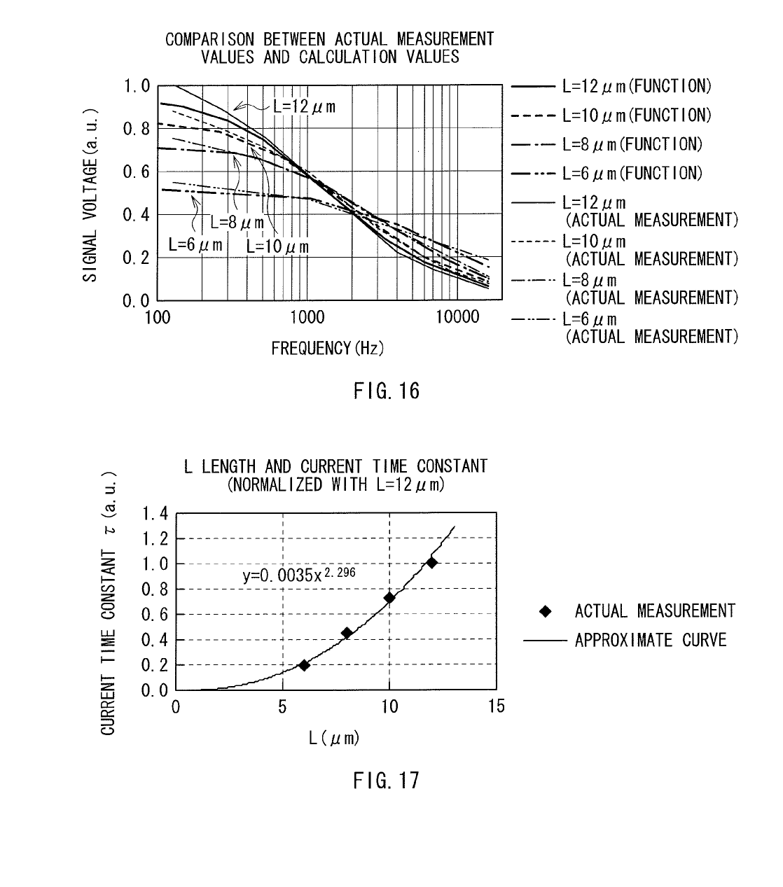

FIG. 16 illustrates the frequency characteristics using the actual measurement values illustrated in FIG. 14A, and the frequency characteristics obtained by fitting and reproducing the frequency characteristics using the actual measurement values with a function of a calculation formula by using the Formula (II) above. In this manner, the frequency characteristics are reproduced by the Formula (II) above. Accordingly, it is possible to obtain the current time constant τ by fitting the frequency characteristics using the actual measurement values with the Formula (II) above.

FIG. 17 illustrates the relationship between the L length and the current time constant τ of the first diode element PD1 based on the actual measurement values with an approximate curve. As seen from FIG. 17, the current time constant τ is more increased as the L length becomes longer. The relationship between τ and the L length is represented by the following formula. “a” represents a constant number.

τ=a·L^{2.3}

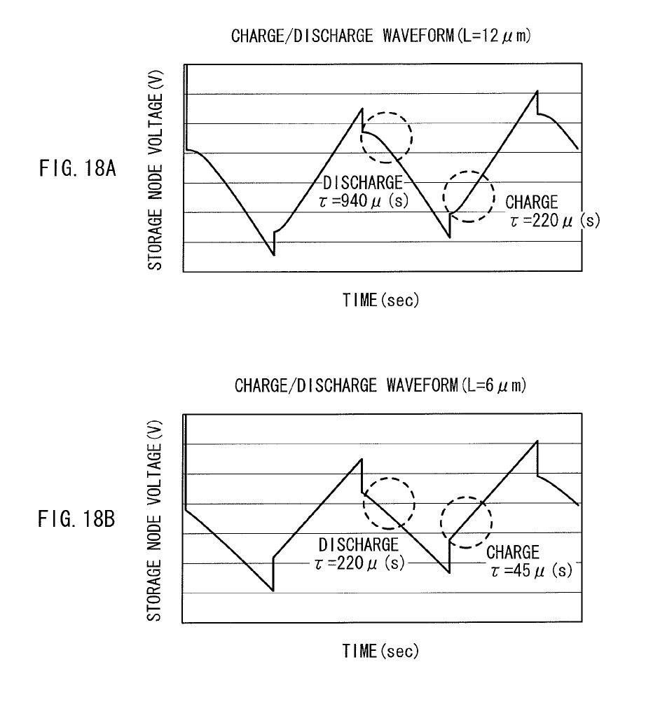

FIGS. 18A and 18B illustrate the charge/discharge waveform (actual measurement values) in the sensor element 33 illustrated in FIG. 5. FIG. 18A illustrates the characteristics in the case where the L length in the first diode element PD1 and the L length of the second diode element PD2 are set as L=12 μm. FIG. 18B illustrates the characteristics in the case where the L length in the first diode element PD1 and the L length of the second diode element PD2 are set as L=6 μm. In FIGS. 18A and 18B, similarly to part (G) of FIG. 9, the voltage waveform in the case where the backlight 15 is in the off state during all the periods, and the reflection light Lon from the proximity object is not present (the case where only the external light component is present), is illustrated.

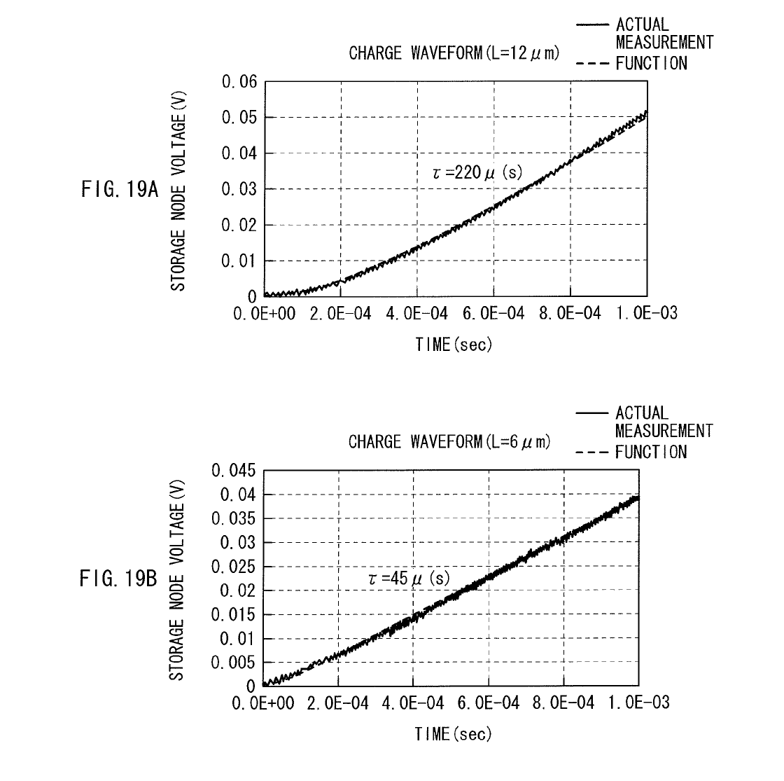

FIG. 19A illustrates in detail the characteristics on the charge side (first diode element PD1) in the charge/discharge waveform illustrated in FIG. 18A. FIG. 19B illustrates the characteristics in detail on the charge side (first diode element PD1) in the charge/discharge waveform illustrated in FIG. 18B. FIGS. 19A and 19B illustrates, at the same time, the charge/discharge waveform using the actual measurement values, and the charge/discharge waveform obtained by fitting and reproducing the charge/discharge waveform using the actual measurement values with the function of the calculation formula by using the Formula (II) above.

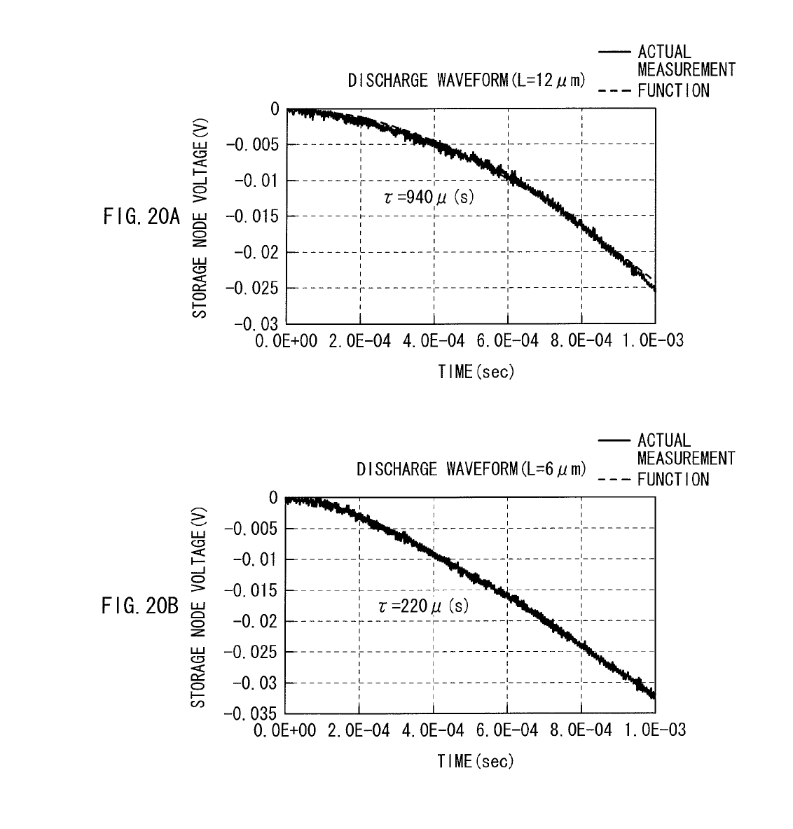

FIG. 20A illustrates in detail the characteristics on the discharge side (second diode element) in the charge/discharge waveform illustrated in FIG. 18A. FIG. 20B illustrates in detail the characteristics on the discharge side (second diode element) in the charge/discharge waveform illustrated in FIG. 18B. FIGS. 20A and 20B illustrate, at the same time, the charge/discharge waveform using the actual measurement values, and the charge/discharge waveform obtained by fitting and reproducing the charge/discharge waveform using the actual measurement values with the function of the calculation formula by using the Formula (II) above.

As illustrated in FIGS. 18A to 20B, in the case where the L length in the first diode element PD1 and the L length in the second diode element PD2 are equal to each other, the saturation speed of the photocurrent (current time constant τ) in the first diode element PD1 at the time of the charge operation, and the saturation speed of the photocurrent in the second diode element PD2 at the time of the discharge operation, are different from each other. In the case where the L length in the first diode element PD1, and the L length in the second diode element PD2 are equal to each other, the relationship of τ1<τ2 is established, where the current time constant of the first diode element PD1 is τ1, and the current time constant of the second diode element PD2 is τ2. Meanwhile, there are characteristics that the current time constant τ becomes smaller as the L length becomes shorter.

From these, the current time constant T1 and the current time constant τ2 become equal to each other, by satisfying the following Condition (1) and making the L length of the second diode element PD2 short, where the L length in the first diode element PD1 is L1, and the L length in the second diode element PD2 is L2.

L2<L1 (1)

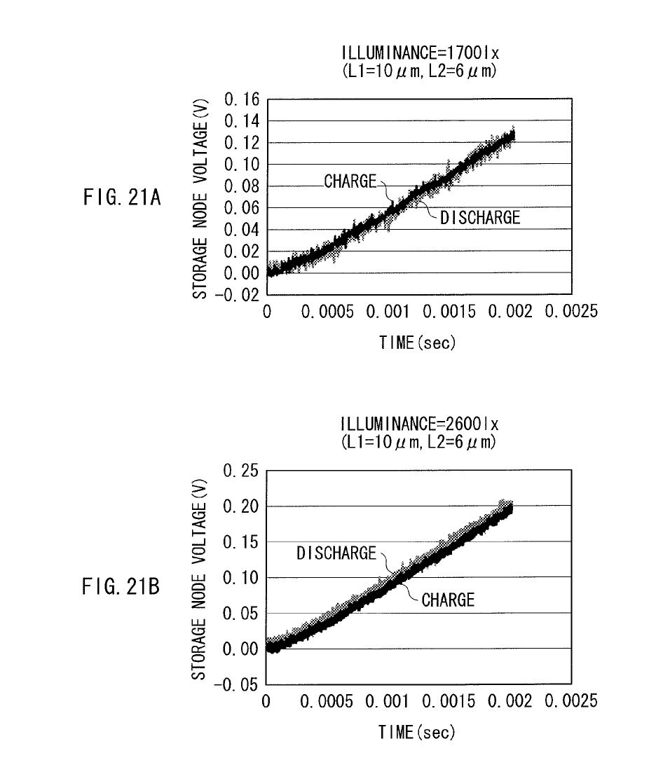

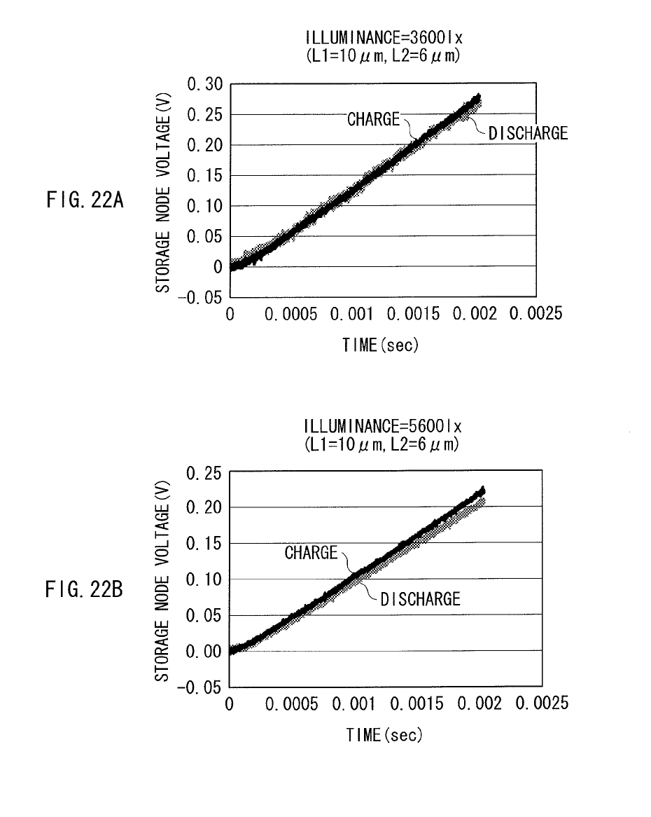

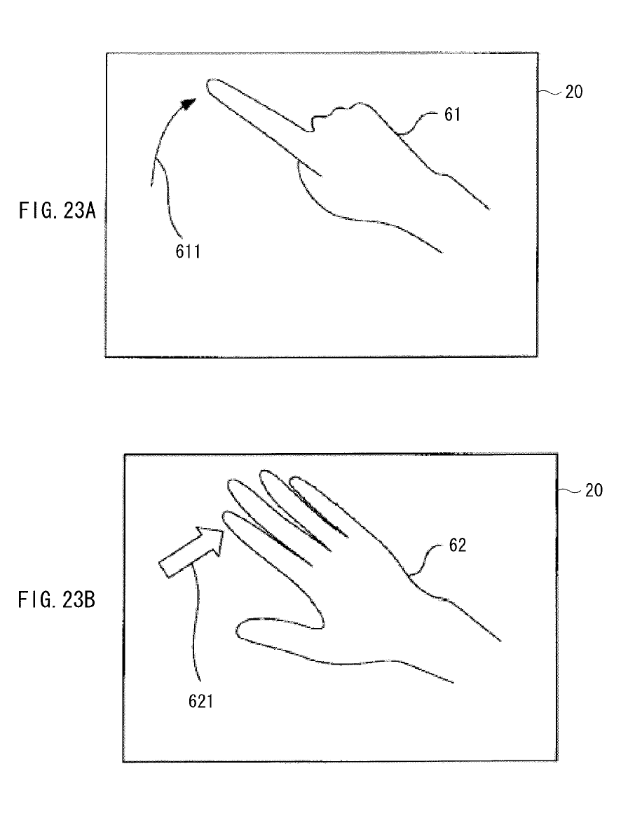

FIGS. 21A to 22B illustrate the illuminance dependency (actual measurement values) in the case where the L length of the first diode element and the L length of the second diode element are set, so that the charge/discharge characteristics are coincident with each other between the first diode element PD1 and the second diode element PD2. FIG. 21A illustrates the charge/discharge characteristics in the case where the external light illuminance is 1700 lx (lux). FIG. 21B illustrates the charge/discharge characteristics in the case where the external light illuminance is 2600 lx. FIG. 22A illustrates the charge/discharge characteristics in the case where the external light illuminance is 3600 lx. FIG. 22B illustrates the charge/discharge characteristics in the case where the external light illuminance is 5600 lx.

As can be seen from FIGS. 21A to 22B, regardless of the illuminance, the characteristics at the time of the charge and the characteristics at the time of the discharge are substantially coincident with each other (response characteristics are coincident with each other). In FIGS. 21A to 22B, L1 equals to 10 μm and L2 equals to 6 μm. Also, the following Condition 2 is substantially satisfied, where the W length in the first diode element PD1 is W1, and the W length in the second diode element PD2 is W2. Specifically, W2 equals to 1.55×W1.

L2·W2=L1·W1 (2)

From the consideration above, the voltage Vsig of the storage node P1 by the charge/discharge operation of the first diode element PD1 and the second diode element PD2 is represented by the following Formula (12) based on the Formula (II). In the Formula (12), Ipin1on represents the current when the first diode element PD1 is in the on state, and Ipin1off represents the current when the first diode element PD1 is in the off state. Ipin2on represents the current when the second diode element PD2 is in the on state, and Ipin2off represents the current when the second diode element PD2 is in the off state. In a charge term of the Formula (12), Ipin1on and Ipin2off are functions in accordance with the external light L0, and the reflection light Lon irradiated from the backlight 15 and then reflected by the proximity object. IRon represents the component by the reflection light Lon, and “amb” represents the component by the external light L0. In a discharge term of the Formula (12), Ipin2on and Ipin1off are functions in accordance with only the external light L0 component. “dt” represents one charge/discharge period. Cst represents the storage node capacity, and “f” represents the number of charge/discharge. α=τ2/τ1 is represented, where the time constant of the first diode element PD1 is τ1, and the time constant of the second diode element PD2 is τ2. τ represents the current time constant.

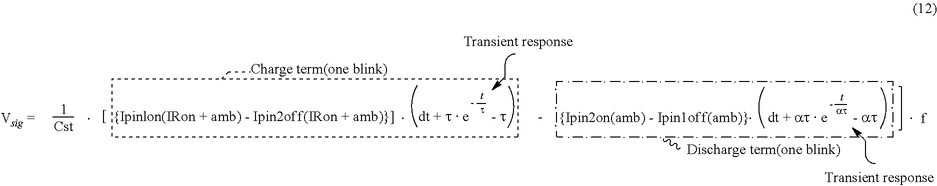

In this manner, according to the display device with the input function according to this example embodiment, since the L length of the intrinsic semiconductor region 54C in the first diode element PD1, and the L length of the intrinsic semiconductor region 54C in the second diode element PD2 are different from each other, it is possible to optimize the L length in the first diode element PD1 and the L length in the second diode element PD2 to reduce the difference in the response characteristics between the first diode elements PD1 and the second diode element PD2. By appropriately setting the L length in the first diode element PD1 and the L length in the second diode element PD2, it is possible to set the time constant τ in the first diode element PD1 and the time constant τ in the second diode element PD2 to be substantially equal to each other (the time constant τ indicates the current response characteristics when the off state is shifted to the on state). Thereby, it is possible to perform the stable detection operation by suppressing the difference in the response characteristics between the first diode element PD1 and the second diode element PD2.

Next, with reference to FIGS. 23A to 26, some application program execution examples by the application program executing section 11, which utilize the position information or the like of the object detected by the above-described detection process of the proximity object will be described.

A first example illustrated in FIG. 23A is an example where the surface of the I/O display panel 20 is touched by a finger 61, and a trace of the touched place is displayed as a draw line 611 on a screen.

A second example illustrated in FIG. 23B is an example by gesture recognition using a hand shape. Specifically, the shape of a hand 62 which is in contact with (or close to) the I/O display panel 20 is recognized, and the recognized hand shape is displayed as an image. Some sort of process is performed based on transfer or movement of that display object (denoted by reference numeral 621).

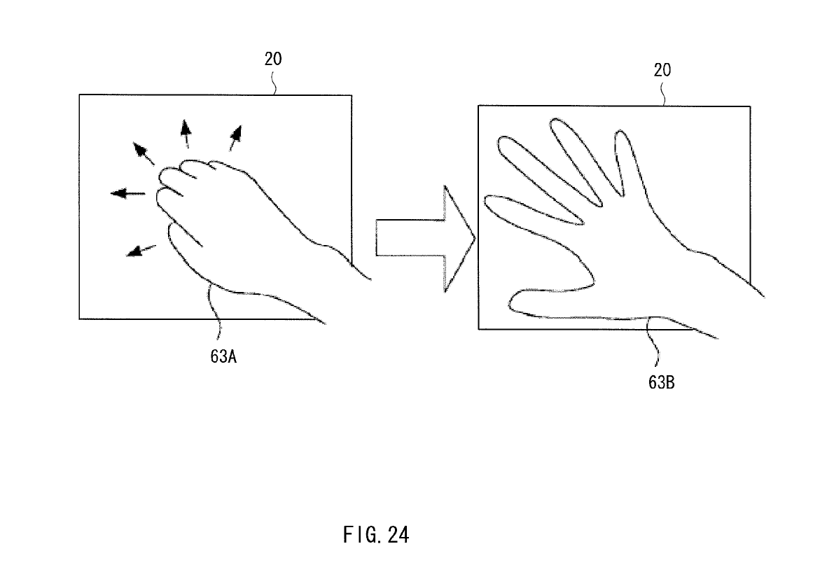

In a third example illustrated in FIG. 24, a hand in a closed state 63A is changed to a hand in an open state 63B. Contact or proximity of the hands in the respective states is recognized in image in the I/O display panel 20, and a process based on that image recognition is performed. By performing the process based on the recognition, instructions such as zoom-in may be given. Since such instructions may be given, for example, the I/O display panel 20 may be connected to a personal computer, and a switching operation or the like of commands performed on that computer device may be more naturally inputted by using this image recognition.

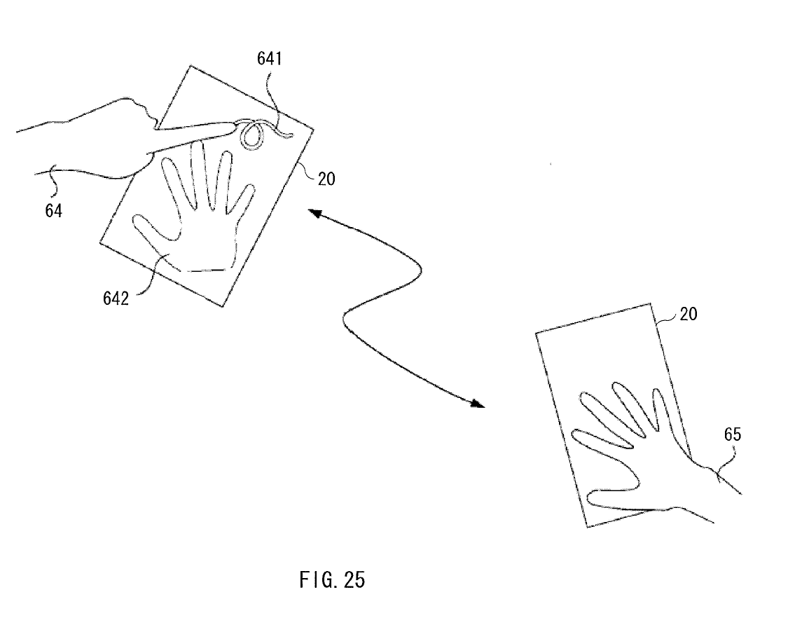

In a fourth example illustrated in FIG. 25, the two I/O display panels 20 are prepared, and the two I/O display panels 20 are connected to each other by some sort of transmission means. In such a structure, an image obtained by detecting the contact or the proximity in one of the I/O display panels 20 is transmitted to the other of the I/O display panels 20 to be displayed, such that users operating these display panels may communicate with each other. For example, as illustrated in FIG. 25, an image of the hand shape of a hand 65 recognized in image in one of the I/O display panels 20 is transmitted, and an image of a hand shape 642 which is the same as the hand shape of the hand 65 may be displayed on the other of the I/O display panels 20. For example, a trace 641 displayed on the other of the I/O display panels 20 by a touch of a hand 64 may be transmitted to one of the I/O display panel 20 to be displayed. In this manner, the draw state is transmitted by a motion image, and handwritten characters, figures, and the like are transmitted to the other side (i.e., a partner). Thereby, there is a possibility that the I/O display panels 20 can be new communication tools. Such an example includes the case where the I/O display panel 20 is applied to a display panel of a mobile phone terminal. In FIG. 25, although the case where the two I/O display panels are used is illustrated, it is possible to connect three or more I/O display panels 20 with the transmission means and to perform the same process.

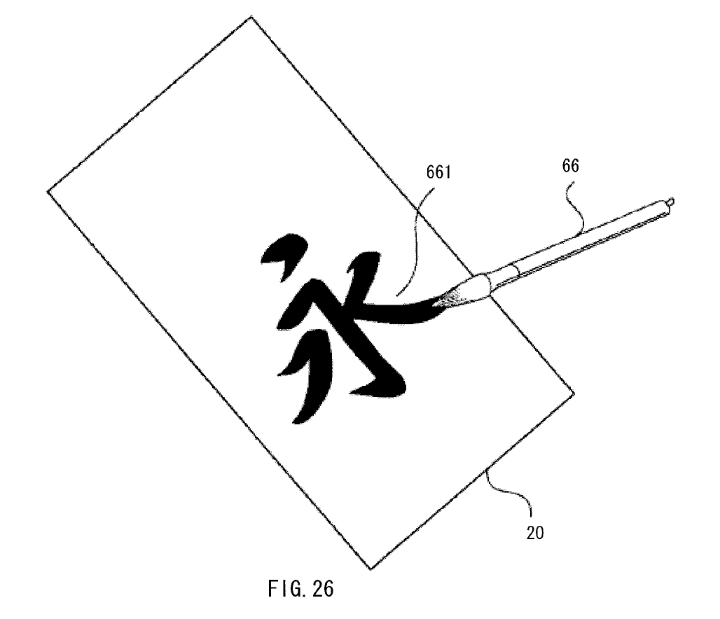

As illustrated in a fifth example of FIG. 26, the surface of the I/O display panel 20 is touched like writing characters with a brush 66, and the place touched by that brush 66 is displayed as an image 661 on the I/O display panel 20. Thereby, it is possible to input the hand-writing by the writing brush. In this case, it is possible to recognize and realize a fine touch of the writing brush. In the case of the existing hand-writing recognition, for example, some of digitizers realize the same by utilizing electric-field detection to detect inclination of a special pen. However, in this example, it is possible to perform the information input with more realistic sense by detecting the contact surface itself of the real writing brush.

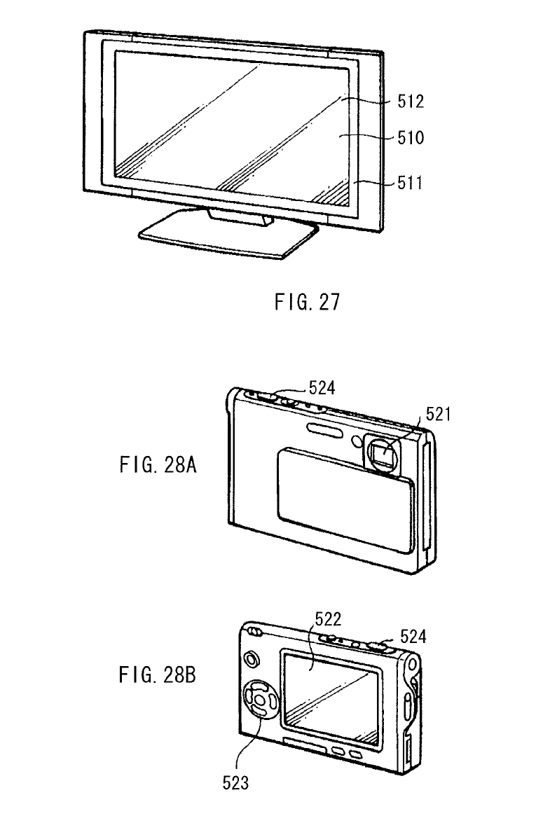

Next, application examples of the above-described display device with the input function will be described with reference to FIGS. 27 to 31G. This display device may be applied to an electronic device of various fields in which a video signal input from the external or a video signal generated inside the device is displayed as an image or a video. For example, it is possible to apply the display device to electric units such as a television device, a digital camera, a notebook personal computer, a mobile terminal device such as a mobile phone, or a video camera which will be described below.

FIG. 27 illustrates an appearance of a television device as a first example of the electric unit. This television device includes, for example, a video display screen 510 including a front panel 511 and a filter glass 512. It is possible to apply the above-described display device with the input function to the video display screen 510 in such a television device.

FIGS. 28A and 28B illustrate an appearance of a digital camera as a second example of the electric unit. This digital camera includes, for example, a light emitting section for a flash 521, a display section 522, a menu switch 523, and a shutter-release button 524. It is possible to apply the above-described display device with the input function to the display section 522 in such a digital camera.

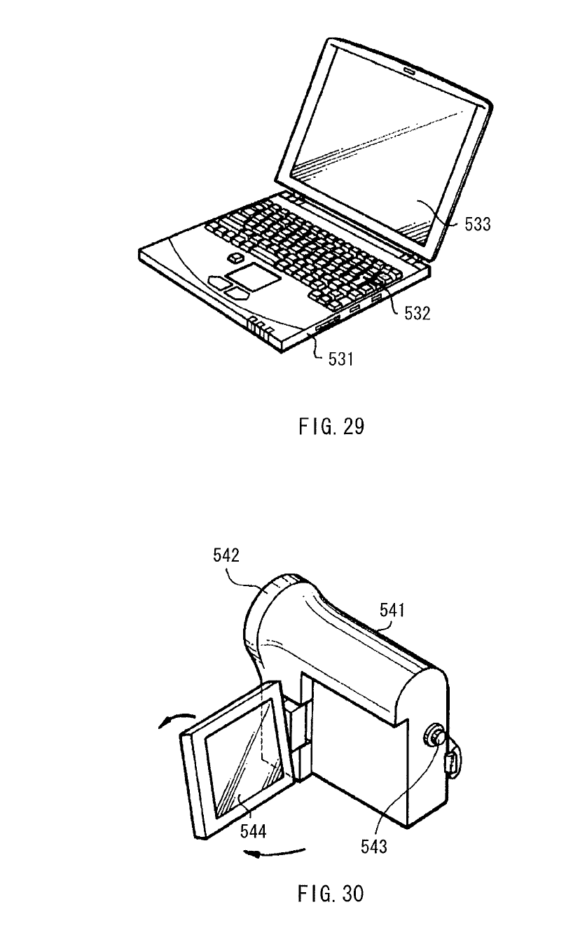

FIG. 29 illustrates an appearance of a notebook personal computer as a third example of the electric unit. The notebook personal computer includes, for example, a main body 531, a keyboard 532 for input operation of characters and the like, and a display section 533 for displaying an image. It is possible to apply the above-described display device with the input function to the display section 533 in such a notebook personal computer.

FIG. 30 illustrates an appearance of a video camera as a fourth example of the electric unit. This video camera includes, for example, a main body 541, a lens for photographing an object 542 provided on the front side face of the main body 541, a start/stop switch 543 in photographing, and a display section 544. It is possible to apply the above-described display device with the input function to the display section 544 in such a video camera.

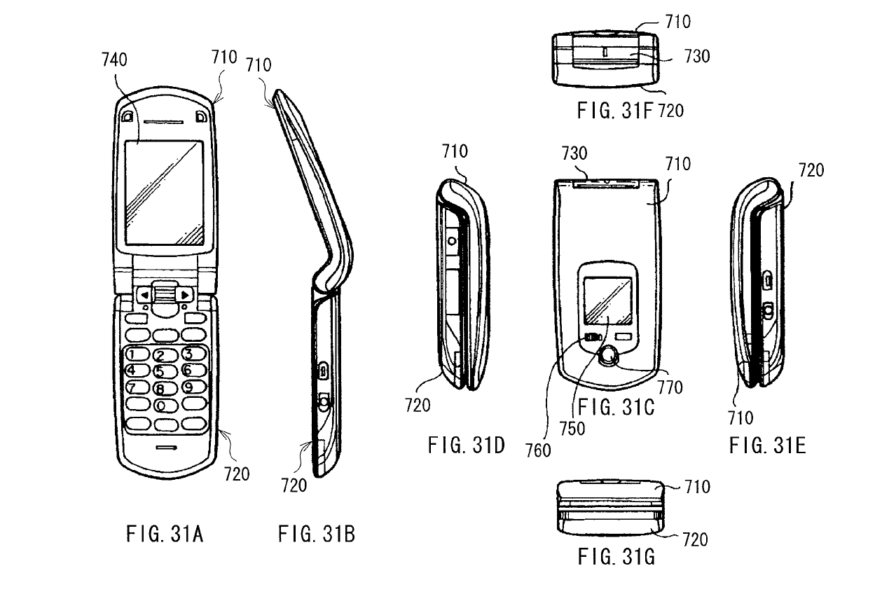

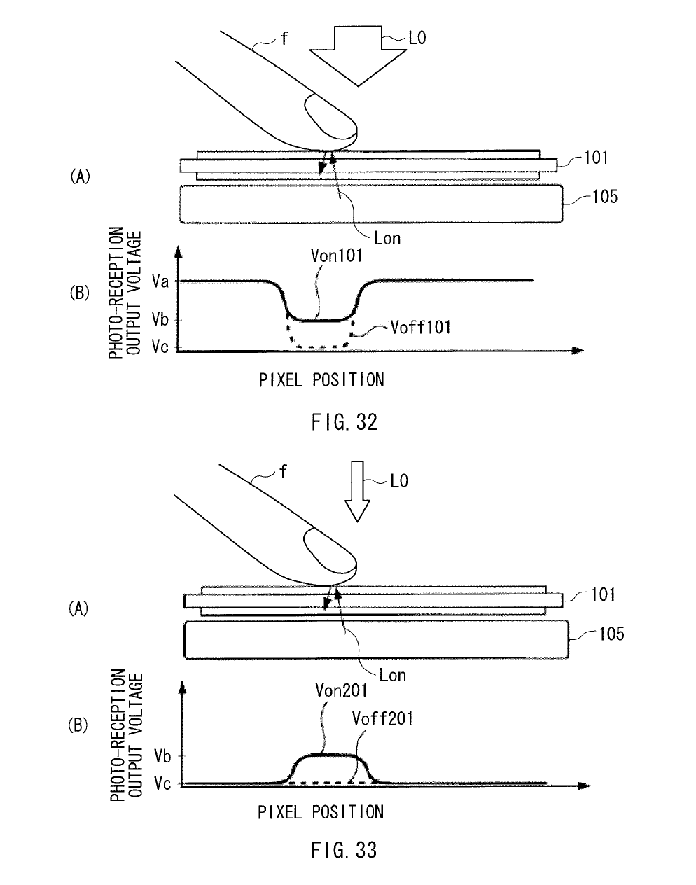

FIGS. 31A to 31G illustrate an appearance of a mobile phone as a fifth example of the electric unit. In this mobile phone, for example, an upper body 710 and a lower body 720 are coupled through a joint section (hinge section) 730. The mobile phone includes a display 740, a sub-display 750, a picture light 760, and a camera 770. It is possible to apply the above-described display device with the input function to the display 740 or the sub-display 750 in such a mobile phone.

The present disclosure is not limited to the above-described example embodiments, and the application examples thereof, and various modifications may be made. For example, in the above-described embodiment and the like, although the case of the I/O display panel 20 formed of the liquid crystal panel including the backlight 15 has been described, the backlight for display may also serve as an illumination for detection, or an illumination used exclusively for detection may be provided. In the case where the illumination for detection is provided, it is preferable to use light (for example, infrared light) having a wavelength region other than a visible light region.

In the above-described example embodiment and the like, although the case where the reset operation or the reading operation is performed (the case where the blinking operation of the backlight at a high frequency may be performed) on the sensor elements 33 of one line in one on-period or one off-period in the backlight 15 has been described, it is not limited to this case. That is, for example, the reset operation or the reading operation may be performed (the blinking operation of the backlight at a low frequency may be performed) on the sensor elements 33 of a plurality of lines in one on-period or one off-period in the backlight 15.

Further, in the above-described example embodiment or the like, although the display device with the input function having the display panel (I/O display panel 20) which includes the plurality of display pixels 31RGB and the plurality of sensor elements 33 has been described, the present disclosure is also applicable to a device other than the display device. For example, the present disclosure may be applied as a sensor device without the display function. In this case, for example, in substitution for the I/O display panel 20, a sensor panel configured by arranging only the plurality of sensor elements 33 in matrix in one plane may be included in the sensor device without the display function, without providing the display pixels 31RGB.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A touch sensor apparatus comprising:
a first photodiode including a first p-type semiconductor region (“p-region”), a first intrinsic semiconductor region (“i-region”), and a first n-type semiconductor region (“n-region”), wherein the first i-region is defined by a first length defined as a first distance of the first i-region between the first p-region and the first n-region;
a second photodiode including a second p-region, a second i-region, and a second n-region, wherein the second i-region is defined by a second length defined as a second distance of the second i-region between the second p-region and the second n-region; and
a sensing component operably coupled to the first photodiode and the second photodiode, the sensing component including a capacitive element;
wherein the first length is different than the second length.

2. The touch sensor apparatus of claim 1, wherein the capacitive element is charged by the first photodiode and discharged by the second photodiode.

3. The touch sensor apparatus of claim 1, wherein the first length is greater than the second length.

4. The touch sensor apparatus of claim 1, wherein the first i-region is defined by the first length and a first width, the first length and the first width defining a first area, the second i-region is defined by the second length and a second width, the second length and second first width defining a second area, and the first area is substantially equal to the second area.

5. The touch sensor apparatus of claim 4, wherein the first length is greater than the second length.

6. The touch sensor apparatus of claim 4, wherein the first width is less than the second width.

7. The touch sensor apparatus of claim 4, wherein the first photodiode and the second photodiode have substantially the same time constant.

8. The touch sensor apparatus of claim 1, wherein the first i-region is defined by the first length and a first width, the second i-region is defined by the second length and a second width, and the first width is less than the second width.

9. The touch sensor apparatus of claim 1, wherein:
the first photodiode and the second photodiode are connected in series;
an input node of the sensing component is connected between the first photodiode and the second photodiode;
the capacitive element is connected between the input node and a power source;
a first transistor is connected between the input node and a reset voltage source, the gate of the first transistor connected to a reset signal line;
a second transistor is connected between the power source and a third transistor, the gate of the second transistor is connected to the input node; and
the third transistor is connected between the second transistor and a read line, the gate of the third transistor connected to a read signal line.

10. The touch sensor apparatus of claim 1, wherein the first photodiode charges the capacitive element during a first time period, the second photodiode discharges the capacitive element during a second time period after the first time period.

11. The touch sensor apparatus of claim 10, wherein the first photodiode charges the capacitive element substantially more than the second photodiode discharges the capacitive element when an object causes a touch state by coming into contact with or close to the touch sensor apparatus during the first time period and the second time period.

12. The touch sensor apparatus of claim 10, wherein and the first photodiode charges the capacitive element substantially the same as the second photodiode discharges the capacitive element when an object is outside the touch sensing range of the touch sensor apparatus during the first time period and the second time period.

13. The touch sensor apparatus of claim 10, wherein the first photodiode charges the capacitive element during a third time period after the second time period, the second photodiode discharges the capacitive element during a fourth time period after the third time period.

14. The touch sensor apparatus of claim 1, wherein the first photodiode and the second photodiode are individually controlled to be turned on and off.

15. The touch sensor apparatus of claim 14, wherein a first electric charge generated in the first photodiode is accumulated in the capacitive element when the first photodiode is turned on and the second photodiode is turned off, and a second electric charge generated in the second photodiode is released from the capacitive element when the second photodiode is turned on and the first photodiode is turned off.

16. The touch sensor apparatus of claim 15, wherein:
the first photodiode includes a first gate electrode, a first anode electrode connected to the first p-region, and a first cathode electrode connected to the first n-region, and the second photodiode includes a second gate electrode, a second anode electrode connected to the second p-region, and a second cathode electrode connected to the second n-region,
the second cathode electrode is connected to the first anode electrode, so that the first diode element and the second diode element are connected to each other in series,
the first photodiode is turned on and off through changing a first potential relationship between the first cathode electrode and the first gate electrode, and
the second photodiode is turned on and off through changing a second potential relationship between the second anode electrode and the second gate electrode.

17. The touch sensor apparatus of claim 16, wherein:
a first fixed voltage is applied to the first gate electrode and a second fixed voltage is applied to the second gate electrode, and
a first pulse is applied to the first cathode electrode and a second pulse is applied to the second anode electrode.

18. The touch sensor apparatus of claim 1, wherein response characteristics of the first photodiode and the second photodiode are different.

19. The touch sensor apparatus of claim 1, further comprising a substrate, which includes a plurality of pixels arranged in a matrix on the substrate for touch sensing, each pixel including a first photodiode, a second photodiode, and a sensing component.

20. An electronic device comprising:
a plurality of pixels, each of the plurality of pixels including:
a first photodiode including a first p-type semiconductor region p-region, a first i-region, and a first n-region, wherein the first i-region is defined by a first length defined as a first distance of the first i-region between the first p-region and the first n-region;
a second photodiode including a second p-region, a second i-region, and a second n-region, wherein the second i-region is defined by a second length defined as a second distance of the second i-region between the second p-region and the second n-region; and
a sensing component operably coupled to the first photodiode and the second photodiode, the sensing component including a capacitive element;
wherein the first length is different than the second length.

21. The electronic device of claim 20, wherein the electronic device is at least one of a television, a digital camera, a personal computer, a notebook computer, a tablet computer, a video camera, and a mobile phone.

22. A display device comprising:
a plurality of display pixels;
a plurality of first photodiodes, each first photodiode including a first p-region, a first i-region, and a first n-region, wherein the first i-region is defined by a first length defined as a first distance of the first i-region between the first p-region and the first n-region;
a plurality of second photodiodes, each second photodiode including a second p-region, a second i-region, and a second n-region, wherein the second i-region is defined by a second length defined as a second distance of the second i-region between the second p-region and the second n-region; and
a plurality of sensing components, each sensing component of the plurality of sensing components operably coupled to a corresponding first photodiode and a corresponding second photodiode and including a capacitive element;
wherein the first length is different than the second length for each of the pluralities of first photodiodes and second photodiodes.

23. A method of driving a touch sensor comprising:
charging a capacitive element, for a first time period, with a first photodiode including a first p-type semiconductor region p-region, a first i-region, and a first n-region, wherein the first i-region is defined by a first length defined as a first distance of the first i-region between the first p-region and the first n-region;
discharging the capacitive element, for a second time period after the first time period, with a second photodiode including a second p-region, a second i-region, and a second n-region, wherein the second i-region is defined by a second length defined as a second distance of the second i-region between the second p-region and the second n-region; and
sensing a charge of the capacitive element after the second time period to determine whether a touch state occurred during the first and second time periods;
wherein the first length is different than the second length.

24. A method of manufacturing a touch sensor apparatus comprising:
charging a capacitive element, for a first time period, with a first photodiode including a first p-type semiconductor region p-region, a first i-region, and a first n-region, wherein the first i-region is defined by a first length defined as a first distance of the first i-region between the first p-region and the first n-region;
discharging the capacitive element, for a second time period after the first time period, with a second photodiode including a second p-region, a second i-region, and a second n-region, wherein the second i-region is defined by a second length defined as a second distance of the second i-region between the second p-region and the second n-region; and
determining a first time constant of a first photodiode by sensing a first charge of the capacitive element during the first time period;
determining a second time constant of a second photodiode by sensing a first charge of the capacitive element during the first second period; and
adjusting at least one of the first length and the second length to cause the first time constant to be substantially equal to the second time constant;
wherein the first length is different than the second length.
